(19) United States
(12) Patent Application Publication
(10) Pub. No.: US 2019/0045195 A1
(43) Pub. Date: Feb. 7, 2019

(54) Reduced Partitioning and Mode Decisions Based on Content Analysis and Learning

(71) Applicant: Intel Corporation, Santa Clara, CA (US)

(72) Inventors: Neelesh Gokhale, Seattle, WA (US); Atul Puri, Redmond, WA (US)

(21) Appl. No.: 15/941,904

(22) Filed: Mar. 30, 2018

(51) Int. Cl. H04N 19/147; H04N 19/103

(52) U.S. Cl. CPC H04N 19/147; H04N 19/567; H04N 19/103

(57) ABSTRACT

Methods, apparatuses and systems may provide for technology that quickly and accurately determines a limited number of partition maps and a limited number of mode subsets. A partition and mode simplification system may include a content analyzer based partitions and mode subset generator system, which itself may include a content analyzer and features generator as well as a partitions and mode subset generator. The content analyzer and features generator may determine a plurality of spatial features and temporal features for a current largest coding unit of a current frame of the video sequence. The partitions and mode subset generator may determine a limited number of partition maps and a limited number of mode subsets for the current largest coding unit of the current frame based at least in part on the spatial features and temporal features.

### TECHNICAL FIELD

Embodiments generally relate to partitioning and mode decisions. More particularly, embodiments relate to technology that reduces partitioning and mode decisions based on content analysis and learning in order to improve compression efficiency during video coding.

### BACKGROUND

In High Efficiency Video Coding (HEVC (and Advanced Video Coding (AVC)) standards based video coding, rate distortion optimization (RDO) is often used to achieve accurate partitioning and mode decision necessary to achieve high coding efficiency. However, RDO is very compute intensive and thus prohibitive for applications where fast and/or real-time encoding is necessary.

Modern video codec standards have significantly increased number of block partitions and modes allowed for coding. This has proportionally increased the encoding complexity since the encoder has to test every partition and mode to select the best partition mode for encoding. Typically, encoders select the best partition and mode using RDO, which has high compute complexity. Such RDO operations often require the complete causal state of encoding to be available during decision, thus making RDO operations very hard to parallelize.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustrative block diagram of an example partition and mode simplification system according to an embodiment;

FIG. 2A is an illustrative block diagram of an example video encoder according to an embodiment;

FIG. 2B is an illustrative block diagram of an example High Efficiency Video Coding video encoder according to an embodiment;

FIG. 3A is an illustrative diagram of an example Largest Coding Unit to Coding Unit partition according to an embodiment;

FIG. 3B is an illustrative diagram of an example of intra prediction partitions sizes and shapes according to an embodiment;

FIG. 3C is an illustrative diagram of an example of Coding Unit to Transform Unit partitions according to an embodiment;

FIG. 4 is an illustrative diagram of an example Group of Pictures structure according to an embodiment;

FIG. 5 is an illustrative diagram of an example Rate Distortion optimization based pattern and mode decision in High Efficiency Video Coding type encoding according to an embodiment;

FIG. 6 is an illustrative block diagram of an example offline training system according to an embodiment;

FIG. 7 is an illustrative block diagram of an example of offline parameter optimization according to an embodiment;

FIG. 8A is an illustrative block diagram of a learning driven fast video encoding implementation of an example partition and mode simplification system according to an embodiment;

FIG. 8B is another illustrative block diagram of an example partition and mode simplification system according to an embodiment;

FIG. 9 is a detailed block diagram of an example content analyzer and features generator according to an embodiment;

FIG. 10 is a detailed block diagram of an example partitioning and mode subset generator according to an embodiment;

FIG. 11 is a detailed block diagram of an example mode subset decider according to an embodiment;

FIG. 12 is a detailed block diagram of an example partitioning map generator according to an embodiment;

FIG. 13 is a detailed block diagram of an example split subset decider according to an embodiment;

FIG. 14 is a detailed block diagram of an example alternative split subset decider according to an embodiment;

FIG. 15 is an illustrative flow chart of an example process of producing a limited number of partition maps and a limited number of mode subsets according to an embodiment;

FIG. 16 is an illustrative flow chart of an example process for the mode subset decider according to an embodiment;

FIG. 17A is an illustrative flow chart of an example process for the split subset decider for inter coding units according to an embodiment;

FIG. 17B is an illustrative flow chart of an example process for the split subset decider for intra/inter coding units according to an embodiment;

FIG. 18 is an illustrative block diagram of an example video coding system according to an embodiment;

FIG. 19 is an illustrative block diagram of an example of a logic architecture according to an embodiment;

FIG. 20 is an illustrative block diagram of an example system according to an embodiment;

FIG. 21 is an illustrative diagram of an example of a system having a small form factor according to an embodiment;

FIG. 22 is an illustrative diagram of an example partition map and mode subset according to an embodiment;

FIG. 23 is an illustrative table of an effectiveness measurement tested on several video sequences according to an embodiment; and

FIG. 24 is an illustrative table of experimental results of quality and speed performance according to an embodiment.

### DETAILED DESCRIPTION

As described above, in High Efficiency Video Coding (HEVC) and Advanced Video Coding (AVC)) standards based video coding, Rate Distortion Optimization (RDO) is often used to achieve accurate partitioning and mode decision necessary to achieve high coding efficiency. However, RDO is very compute intensive and thus prohibitive for applications where fast and/or real-time encoding is necessary. Modern video codec standards have significantly increased number of block partitions and modes allowed for coding. This has proportionally increased the encoding complexity since the encoder has to test every partition and mode to select the best partition mode for encoding. Typically, encoders select the best partition and mode using RDO, which has high compute complexity. Such RDO operations often require the complete causal state of encoding to be available during decision, thus making RDO operations very hard to parallelize.

Of the numerous available solutions that offer lower complexity alternatives to full RDO, none adequately provide comprehensive solution to the problem of correctly being able to project partitioning and/or mode decisions that would result in efficient HEVC coding at low computational complexity.

For example, these available solutions may suffer from one or more of the following deficiencies: low robustness or reliability (e.g., due to use of a few, sometimes not very reliable features); high computational complexity to determine estimated partitions, or mode projections; high instances of incorrect partitioning, or mode projections leading to loss in quality; high delay (e.g., a need to buffer several frames of video for analysis of content); and high failure rates for complex content and noisy content.

Available techniques to speed up partitioning often depend on in-loop Largest Coding Unit (LCU) based reduction of Rate Distortion (RD) using techniques like early exits. Some available techniques use mode decision speedup operations based on correlations with previous encoding state (e.g., like causal coding units (CUs) and collocated CU). These available techniques often suffer from the same in-loop LCU based decision architecture, and cannot independently partition or predict modes for higher parallelization.

Some available transcoding techniques may use decisions from previous encodes, usually mapping across standards and using machine learning to pre-decide current encoding mode and decision. Although highly parallelizable, such available techniques only work if the video to be encoded is already in a known video codec standard.

Available content analysis and classification based techniques have been used to predict an in-loop CU mode. Some such systems may try to classify CU splits as a binary classification using in-loop causal encoder state or directly from content analysis. Typically, available classification based systems may suffer from compression efficiency loss, since classifiers always have to choose one of the possible classes. Accordingly, the loss in efficiency may be directly related to accuracy of classification, which may not be high in available techniques. It should also be noted that Non-Parametric Machine Learning (ML) techniques, like support vector machines (SVM), and neural nets (NN) based classification may also very compute intensive. For fast video encoders, the classification complexity using SVM and NN could be higher than mode decision complexity would permit.

As will be described in greater detail below, implementations described herein may provide an alternative to full RDO that seeks to reduce computational complexity of encoding by content analysis, coding conditions evaluation (e.g., bitrate), and learning based decisions to project anticipated partitions and mode decisions for each coding unit/block of a frame prior to encoding.

In some implementations, a fast and low complexity method of partitioning for efficient video coding by the HEVC standard is described. This method of partitioning may involve partitioning of fixed size largest coding units/blocks of each frame into smaller variable size blocks/partitions for motion compensation and transform coding. Such partitioning may be based on properties of content (of each block in a frame), available coding bitrate, and learning based decision making. Further, using similar principles, a method for projecting most likely coding mode(s) for partition prior to actual coding is also described. These two methods, when combined, may provide a much lower complexity content, coding conditions, and learning based alternative, as opposed to a brute-force RDO based solution (e.g., that may be few hundred or even few thousands of time more compute intensive).

These two methods for partitioning and mode projection may perform efficient video coding at low complexity with modern standards such as HEVC, AVC, VP9, and AOMedia Video 1 (AV1). In particular, for HEVC coding, some implementations herein may presents a good guess of partitions and modes as a reduced set of candidates to try out for encoding of coding units/blocks of each frames, prior to actual encoding Some implementations may improve quality of software codecs, GPU accelerated codecs, and/or hardware video codecs. Some implementations may provide some or all of the following advantages: a high robustness/reliability (e.g., as decision making may employ multiple basis, including machine learning); a low computational complexity to determine estimated partitions, and/or mode decisions (e.g., as multiple basis, including content analysis, may be used); a reduced instances of incorrect partitioning or mode decisions (e.g., as bit-rate is also used as a basis in addition to other basis); an elimination of a delay of several frames (e.g., as there is no need to look ahead several frames as all processing may be done independently for each frame without knowing the future variations in content); a low failure rate for even complex content, or noisy content (e.g., due to use of content analysis, coding conditions analysis, and machine learning based modeling as basis); a small footprint that may permit a software implementation that is fast or permit easy to optimization for hardware. Additionally or alternatively, some implementations may provide some or all of the following advantages: implementations that may work with state-of-the-art video coding standards (e.g., HEVC/AV1 and AVC); implementations that may be applicable not only to normal delay video coding but also to low delay video coding; implementations that may provide significant speedup in encoding as compared to available techniques; implementations that may guarantee a certain maximum encode complexity; implementations that may produce better compression efficiency compared to available techniques; implementations that may provide more parallelization in encoding as compared to available techniques; and implementations that may have lower complexity than available non-parametric ML systems.

These two methods for partitioning and mode projection may perform efficient video coding at low complexity with modern standards such as HEVC, AVC, VP9, and AOMedia Video 1 (AV1). For example, implementations herein may be utilized in state-of-the art video coding standards such as ITU-T H.264/ISO MPEG AVC (AVC) and ITU-T H.265/ISO MPEG HEVC (HEVC), as well as standards currently in development such as ITU-T H.266 and AOM AV1 standard. These video coding standards standardize bitstream description and decoding semantics, which, while they define an encoding framework, they leave many aspects of encoder algorithmic design open to innovation. Accordingly, the only consideration is that the encoding process generates encoded bitstreams that are compliant to the standard. The resulting bitstreams are then assumed to be decodable by any device or application claiming to be compliant to the standard. Bitstreams resulting from codec implementations described herein (e.g., with partitioning and/or mode decision improvements) are compliant to the relevant standard and can be stored or transmitted prior to being received, decoded and displayed by an application, player, or device.

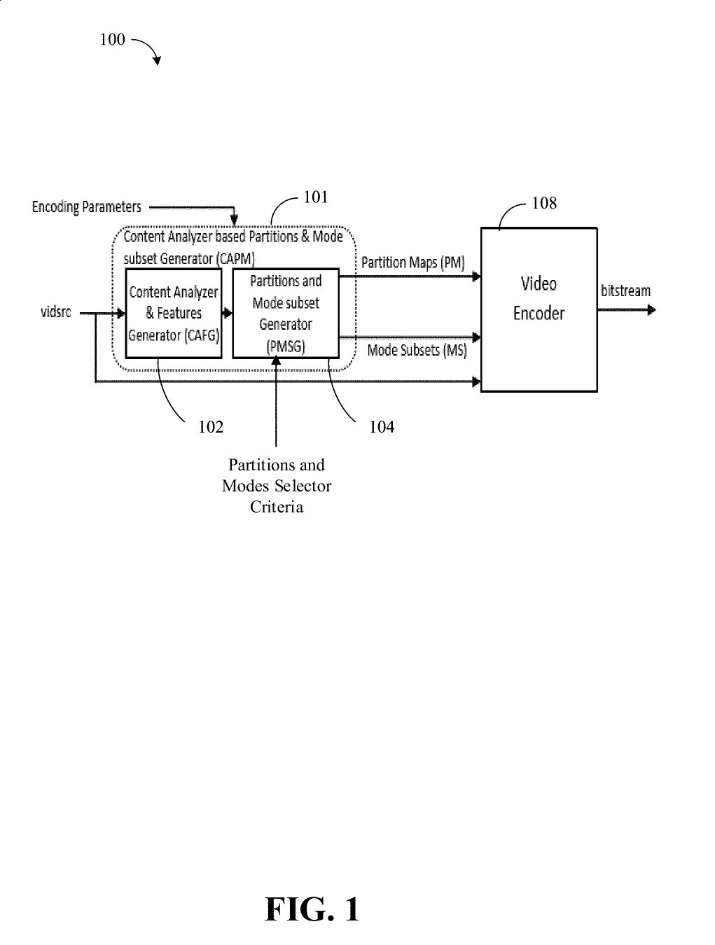

FIG. 1 is an illustrative block diagram of an example partition and mode simplification system 100, arranged in accordance with at least some implementations of the present disclosure. In various implementations, partition and mode simplification system 100 may include a content analyzer based partitions and mode subset generator (CAPM) system 101. Content analyzer based partitions and mode subset generator (CAPM) system 101 may use a content analyzer and features generator (CAFG) 102 and partitioning and mode subsets generator (PMSG) 104. Some implementations herein may utilize content analysis using content analyzer and features generator (CAFG) 102 to generate features for partition and mode selection. Functions (called intelligent encoder functions (IEF)) may be trained to predict a single partition or mode with high confidence. These IEFs may use parametric spatial-temporal complexity curves, feature weights, and/or feature thresholds for prediction. Partitioning and mode subsets generator (PMSG) 104 may use these IEFs by cascading them logically and recursively to create partitions and mode subsets maps. This differs from typical multi class classifiers, which usually have to classify into one of possible classes and may not always know the error probability of classification.

Content analyzer and features generator (CAFG) 102 may be implemented as a pre-analyzer, which may provide low-level video metrics and features. Content analyzer and features generator (CAFG) 102 may use spatial analysis and a graphics processing unit (GPU) video motion estimation (VME) engine to provide metrics like spatial complexity per-pixel detail (SCpp), measure of temporal complexity per-pixel (SADpp), and motion vectors (MV). Features such as motion vector differential (MVD), temporal complexity variation metric (SADvar), temporal complexity reduction (SADred), and spatial complexity variation (SCvar) may be derived from the above metrics. Based on these low level features, the partitions and mode subset generator (PMSG) 104 may compute a reduced number of encoding Mode Subsets (MS) and reduced number of Partition Maps (PM).

In operation, CAPM system 101 may break the in-loop optimization paradigm of encoding. Instead, CAPM system 101 may perform frame based operations without requiring codec state or in-loop LCU based operations. CAPM) system 101 may generate partitioning maps and mode subset maps for an entire frame of video, which may be used by a video encoder 108 to perform limited RDO based decisions as directed by the partitioning maps and mode subset maps to encode a frame.

As shown, CAPM system 101 generates at least 1 complete partitioning map and a mode subset per partition with at least 1 mode per partition for all LCUs. Mode subsets allows maximum of 2 modes per partition, and also allows mode subsets with just 1 mode where prediction can be made with high confidence. CAPM system 101 knows the probability of error in prediction of partition and modes so CAPM system 101 may also provides an alternate partition and mode subset, so that the encoder can minimize cost for encoding using RDO. Using alternate partitions and mode subsets shows significantly higher compression efficiency than just classification. CAPM system 101 guarantees that the video encoder 108 will never test more than 2 partitioning's and never more than 2 modes per partition, thus providing significant reduction in complexity. Typically, the alternate partition may be used only for a small area of the video.

In operation, CAPM system 101 provides for fast and efficient encoding by providing a reduced decision set with only 1 or 2 choices for the video encoder 108. One of four reduced encoding mode sets (e.g., Inter_Skip, Inter_Only, Intcr_Intra, and Intra_Only) is assigned to every partition (e.g., coding unit), with no decision required for Inter_Only or Intra_Only, and only 1 mode decision required for Inter_Skip and Inter_Intra mode sets. Partitions and mode subset generator (PMSG) 104, at its core, uses offline trained functions called intelligent encoder functions (IEF) to select a single mode or split decision with high confidence. As illustrated, Partitions and mode subset generator (PMSG) 104 receives partitioning and modes selector criteria, which may be adjusted based on application type, user choice, learning system, or by using and expert intelligence (e.g., Artificial Intelligence). By reducing the numbers of partitions and mode choices, video encoder 108 may be made with improved speed with an acceptable loss in quality.

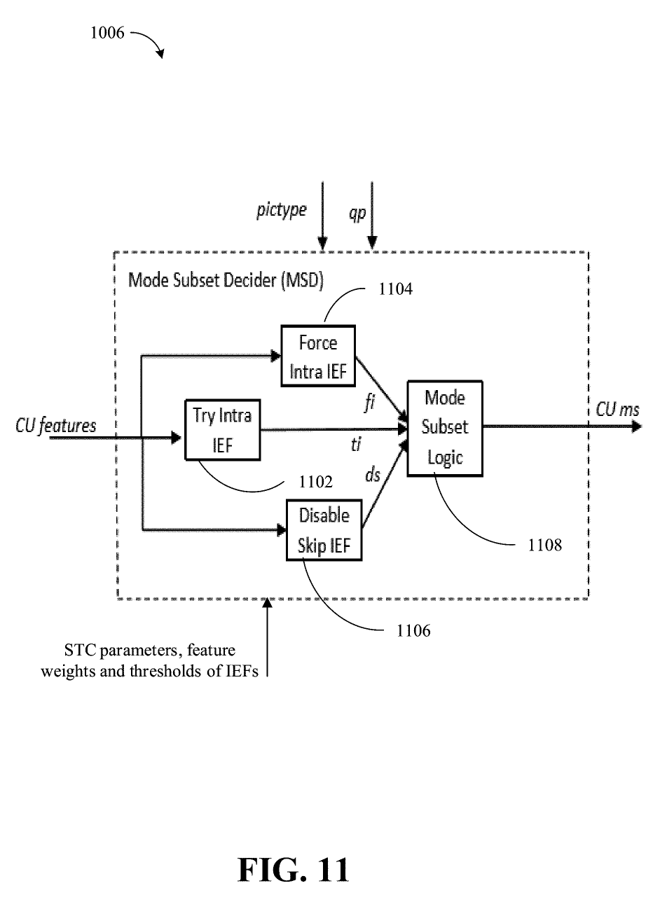

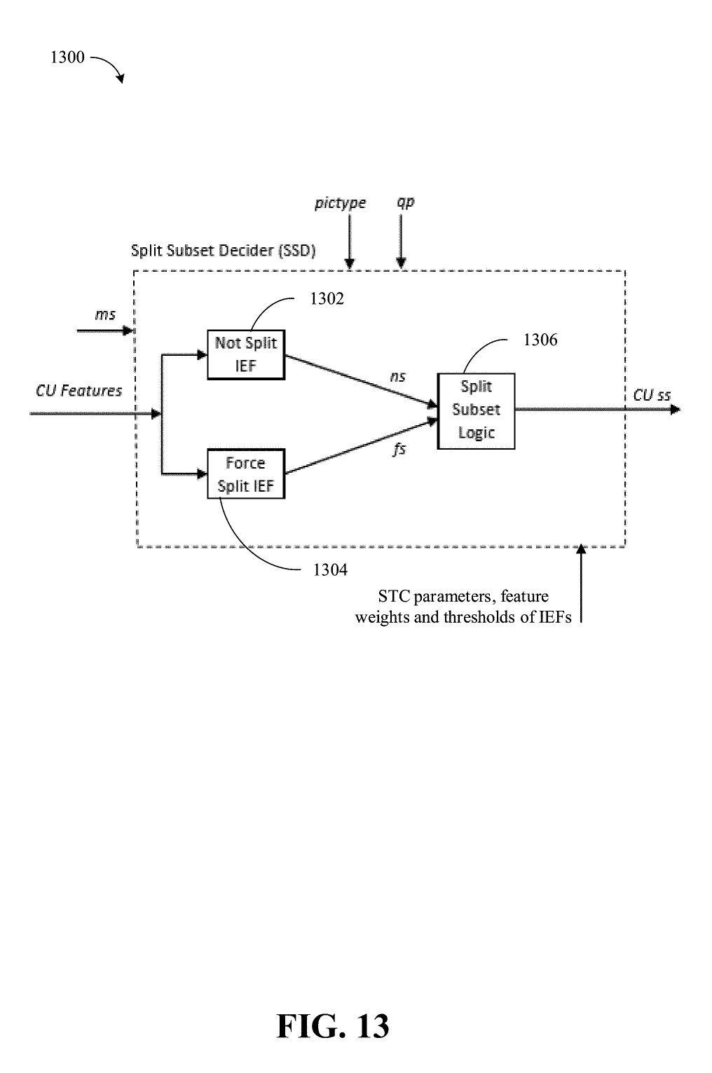

In some examples, such partitioning and modes selector criteria may include spatial-temporal complexity (STC) parameters, feature weights, and thresholds of intelligent encoder functions (IEF), all of which will be described in greater detail below. For example, each intelligent encoder function (IEF) includes trained parameters for spatial-temporal complexity functions, weights & thresholds for features for multiple representative quantizer (Qp), frame level (PicLvl), and coding unit size (CUsz) conditions. The intelligent encoder functions (IEF) are logically combined in the Mode Subset Deciders (MSD) (FIG. 11) and a Split Subset Deciders (SSD) (FIG. 13) to generate an encoding mode subset and a split subset for each CU size. Partitions and mode subset generator (PMSG) 104 may recursively cascade and logically combine Mode Subset Deciders (MSD) (FIG. 11) and Split Subset Deciders (SSD) to generate the partition maps and mode subsets.

The important difference in intelligent encoder functions (IEF) and Machine Learning (ML)/Bayesian classifiers is that they do not have to always select a mode or split class; instead, they select with high confidence only one single mode or split class. Partitions and mode subset generator (PMSG) 104 uses the intelligent encoder functions (IEF) by logical & recursively cascading them to provide the Mode Sets and Partition Maps. Selectors are classifier with high confidence for one class. The confidence metric may depend on the class and is either Precision or Sensitivity of classification. Precision or Sensitivity based best classification can be achieved by maximizing the classification performance metric Fbeta scores in training where beta controls the precision or sensitivity required.

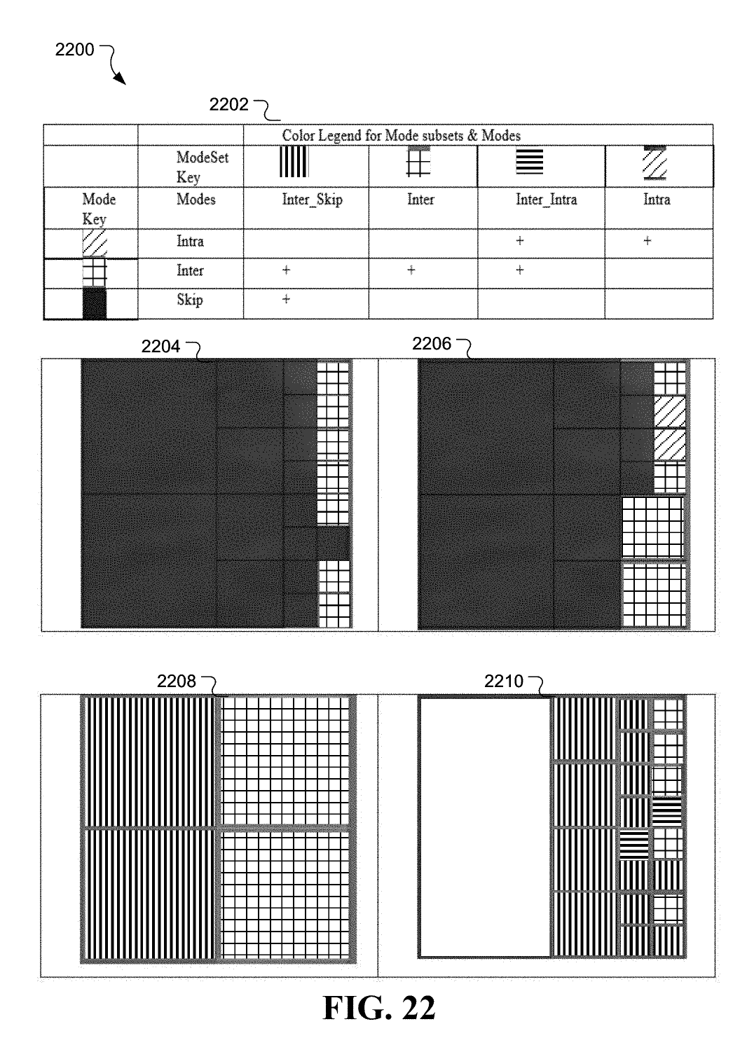

FIG. 22 is an illustrative diagram of an example partition map and mode subset 2200, arranged in accordance with at least some implementations of the present disclosure. In various implementations, partition map and mode subset 2200 includes a table 2202 including a legend illustrating mode subsets.

As illustrated, a final LCU partitioning map and mode subset 2204 for a LCU (29, 4) of a frame of a touchdown pass video frame number 150 at quantization qp27 may be derived using the implementations discussed herein. A total of 43 rate distortion costs were evaluated to arrive at this partition and mode decision. A Final partitioning map and mode subset 2206 for the same LCU (29, 4) of a touchdown pass video frame number 150 at quantization qp27 using an optimal reference HEVC encoder (HM) is illustrated on the right hand side of the figure. The optimal reference HEVC encoder (HM) evaluates 255 rate distortion costs (e.g., 85 coding units with 3 modes each) to arrive at this partitioning and mode decision. Accordingly, it can be seen that the final LCU partitioning map and mode subset 2204 derived using the implementations discussed herein uses a substantially lower number of rate distortion costs as compared with operations of an optimal reference HEVC encoder (HM).

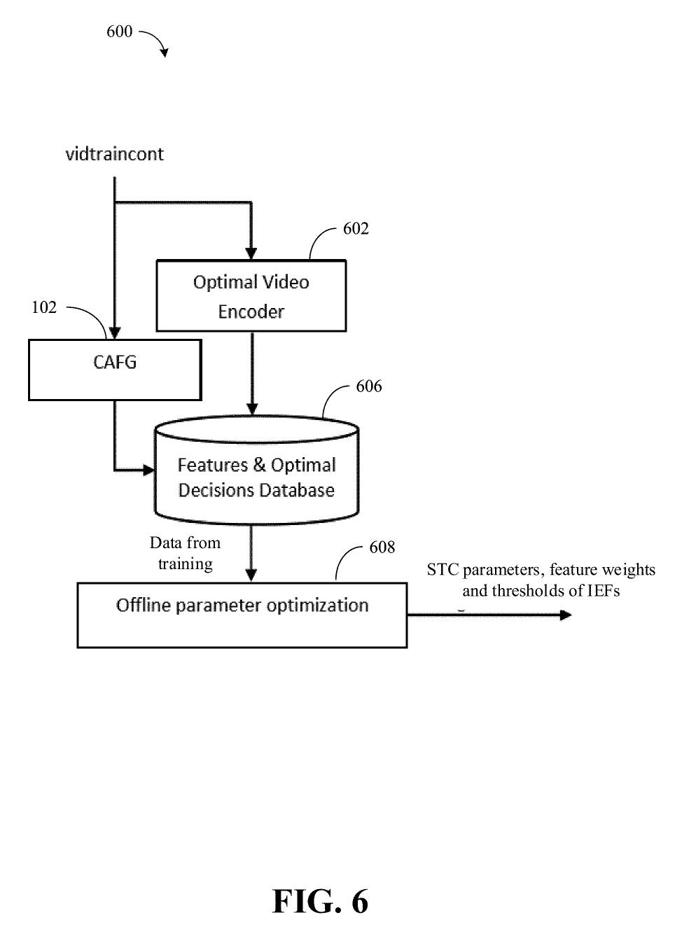

Similarly, a primary partition and mode set 2208 requires only 8 rate distortion costs during evaluation (e.g., 4 coding units, each having 2 modes). Additionally, an alternate partition and mode set 2210 for LCU (29,4) is illustrated, where 35 rate distortion costs were evaluated. The systems disclosed herein are learning driven and use an optimal reference HEVC HM Encoder partitions and modes as an ideal reference data to learn from during a learning phase, as will be described in greater detail below with regard to FIG. 6. Accordingly, both the primary partition and the alternate partition and mode set result are not the direct outcome of RDO of an optimal reference HEVC HM Encoder, but benefit from such operations from the learning phase.

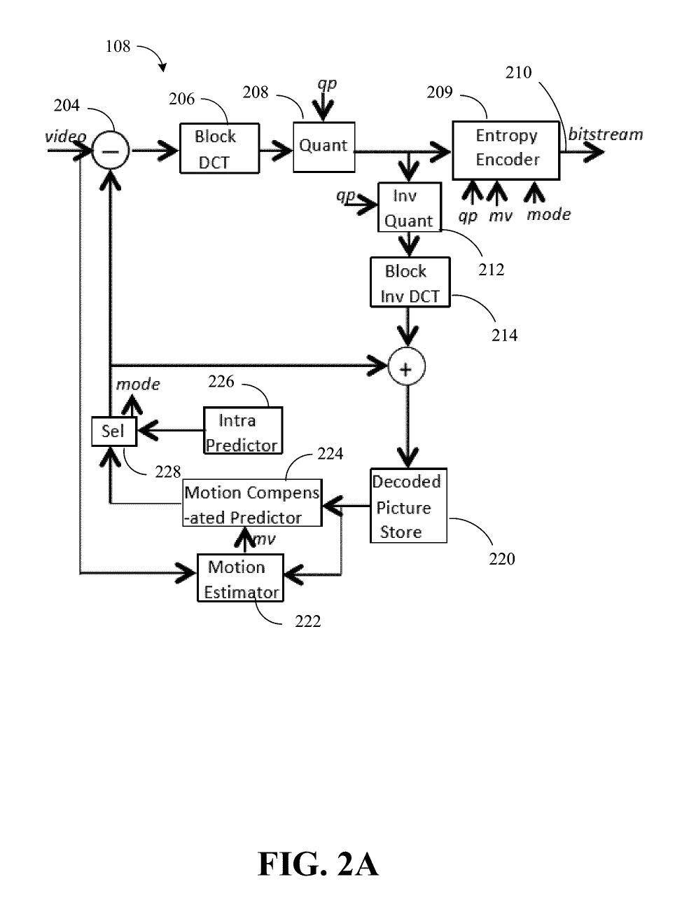

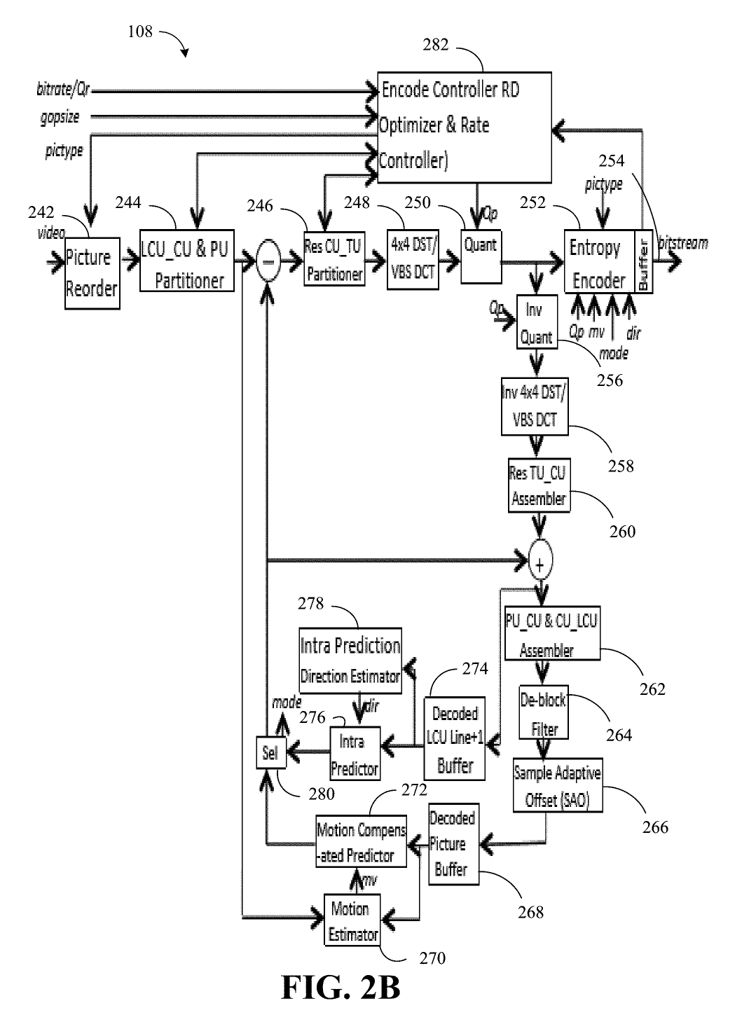

FIG. 2A is an illustrative block diagram of an example video encoder 108, arranged in accordance with at least some implementations of the present disclosure. In various implementations, video encoder 108 may be configured to undertake video coding and/or implement video codecs according to one or more advanced video codec standards, such as, for example, the Advanced Video Coding (e.g., AVC/H.264) video compression standard or the High Efficiency Video Coding (e.g., HEVC/H.265) video compression standard, but is not limited in this regard. Further, in various embodiments, video encoder 108 may be implemented as part of an image processor, video processor, and/or media processor.

As used herein, the term “coder” may refer to an encoder and/or a decoder. Similarly, as used herein, the term “coding” may refer to encoding via an encoder and/or decoding via a decoder. For example video encoder 108 may include a video encoder with an internal video decoder, as illustrated in FIG. 2A, while a companion coder may only include a video decoder (not illustrated independently here), and both are examples of a “coder” capable of coding.

In some examples, video encoder 108 may include additional items that have not been shown in FIG. 2A for the sake of clarity. For example, video encoder 108 may include a processor, a radio frequency-type (RF) transceiver a display, an antenna, and/or the like. Further, video encoder 108 may include additional items such as a speaker, a microphone, an accelerometer, memory, a router, network interface logic, and/or the like that have not been shown in FIG. 2 for the sake of clarity.

Video encoder 108 may operate via the general principle of inter-frame coding, or more specifically, motion-compensated (DCT) transform coding that modern standards are based on (although some details may be different for each standard). Inter-frame coding includes coding using up to three types picture types (e.g., I-pictures, P-Pictures, and B-pictures) arranged in a fixed or adaptive picture structure that is repeated a few times and collectively referred to as a group-of-pictures. I-pictures are typically used to provide clean refresh for random access (or channel switching) at frequent intervals. P-pictures are typically used for basic inter-frame coding using motion compensation and may be used successively or intertwined with an arrangement of B-pictures; where, P-pictures may provide moderate compression. B-pictures that are bidirectionally motion compensated and coded inter-frame pictures may provide the highest level of compression.

Since motion compensation is difficult to perform in the transform domain, the first step in an interframe coder is to create a motion compensated prediction error in the pixel domain. For each block of current frame, a prediction block in the reference frame is found using motion vector computed during motion estimation, and differenced to generate prediction error signal. The resulting error signal is transformed using 2D DCT, quantized by an adaptive quantizer (e.g., “quant”) 208, and encoded using an entropy coder 209 (e.g., a Variable Length Coder (VLC) or an arithmetic entropy coder) and buffered for transmission over a channel.

The entire interframe coding process involves bitrate/coding error (distortion) tradeoffs with the goal of keeping video quality as good as possible subject to needed random access and within the context of available bandwidth. The key idea in modern interframe coding is to combine temporally predictive coding that adapts to motion of objects between frames of video and is used to compute motion compensated differential residual signal, and spatial transform coding that converts spatial blocks of pixels to blocks of frequency coefficients typically by DCT (of block size such as 8×8) followed by reduction in precision of these DCT coefficients by quantization to adapt video quality to available bit-rate.

Since the resulting transform coefficients have energy redistributed in lower frequencies, some of the small valued coefficients after quantization turn to zero, as well as some high frequency coefficients can be coded with higher quantization errors, or even skipped altogether. These and other characteristics of transform coefficients such as frequency location, as well as that some quantized levels occur more frequently than others, allows for using frequency domain scanning of coefficients and entropy coding (in its most basic form, variable word length coding) achieving additional compression gains.

As illustrated, the video content may be differenced at operation 204 with the output from the internal decoding loop 205 to form residual video content.

The residual content may be subjected to video transform operations at transform module (e.g., “block DCT”) 206 and subjected to video quantization processes at quantizer (e.g., “quant”) 208.

The output of transform module (e.g., “block DCT”) 206 and quantizer (e.g., “quant”) 208 may be provided to an entropy encoder 209 and to an inverse transform module (e.g., “inv quant”) 212 and a de-quantization module (e.g., “block inv DCT”) 214. Entropy encoder 209 may output an entropy encoded bitstream 210 for communication to a corresponding decoder.

Within an internal decoding loop of video encoder 108, inverse transform module (e.g., “inv quant”) 212 and de-quantization module (e.g., “block inv DCT”) 214 may implement the inverse of the operations undertaken transform module (e.g., “block DCT”) 206 and quantizer (e.g., “quant”) 208 to provide reconstituted residual content. The reconstituted residual content may be added to the output from the internal decoding loop to form reconstructed decoded video content. Those skilled in the art may recognize that transform and quantization modules and de-quantization and inverse transform modules as described herein may employ scaling techniques. The decoded video content may be provided to a decoded picture store 120, a motion estimator 222, a motion compensated predictor 224 and an intra predictor 226. A selector 228 (e.g., “Sel”) may send out mode information (e.g., intra-mode, inter-mode, etc.) based on the intra-prediction output of intra predictor 226 and the inter-prediction output of motion compensated predictor 224. It will be understood that the same and/or similar operations as described above may be performed in decoder-exclusive implementations of Video encoder 108.

FIG. 2B is an illustrative diagram of an example video encoder 108, arranged in accordance with at least some implementations of the present disclosure. In various implementations, video encoder 108 may be configured to undertake video coding and/or implement video codecs according to one or more advanced video codec standards, such as, for example, the Advanced Video Coding (e.g., AVC/H.264) video compression standard or the High Efficiency Video Coding (e.g., HEVC/H.265) video compression standard, but is not limited in this regard. Further, in various embodiments, video encoder 108 may be implemented as part of an image processor, video processor, and/or media processor.

In some examples, during the operation of video encoder 108, current video information may be provided to a picture reorder 242 in the form of a frame of video data. Picture reorder 242 may determine the picture type (e.g., I-, P-, or B-frame) of each video frame and reorder the video frames as needed.

The current video frame may be split from Largest Coding Units (LCUs) to coding units (CUs), and a coding unit (CU) may be recursively partitioned into smaller coding units (CUs); additionally, the coding units (CUs) may be partitioned for prediction into prediction units (PUs) at prediction partitioner 244 (e.g., “LC_CU & PU Partitioner). A coding partitioner 246 (e.g., “Res CU_TU Partitioner) may partition residual coding units (CUs) into transform units (TUs).

The coding partitioner 246 may be subjected to known video transform and quantization processes, first by a transform 248 (e.g., 4×4DCT/VBS DCT), which may perform a discrete cosine transform (DCT) operation, for example. Next, a quantizer 250 (e.g., Quant) may quantize the resultant transform coefficients.

The output of transform and quantization operations may be provided to an entropy encoder 252 as well as to an inverse quantizer 256 (e.g., Inv Quant) and inverse transform 258 (e.g., Inv 4×4DCT/VBS DCT). Entropy encoder 252 may output an entropy encoded bitstream 254 for communication to a corresponding decoder.

Within the internal decoding loop of video encoder 108, inverse quantizer 256 and inverse transform 258 may implement the inverse of the operations undertaken by transform 248 and quantizer 250 to provide output to a residual assembler 260 (e.g., Res TU_CU Assembler).

The output of residual assembler 260 may be provided to a loop including a prediction assembler 262 (e.g., PU_CU & CU_LCU Assembler), a de-block filter 264, a sample adaptive offset filter 266 (e.g., Sample Adaptive Offset (SAO)), a decoded picture buffer 268, a motion estimator 270, a motion compensated predictor 272, a decoded largest coding unit line plus one buffer 274 (e.g., Decoded LCU Line+1 Buffer), an intra prediction direction estimator 276, and an intra predictor 278. As shown in FIG. 2B, the output of either motion compensated predictor 272 or intra predictor 278 is selected via selector 280 (e.g., Sel) and may be combined with the output of residual assembler 260 as input to de-blocking filter 114, and is differenced with the output of prediction partitioner 244 to act as input to coding partitioner 246. An encode controller 282 (e.g., Encode Controller RD Optimizer & Rate Controller) may operate to perform Rate Distortion Optimization (RDO) operations and control the rate of video encoder 108.

In operation, video encoder 108, like any MPEG/ITU-T video standards (including the HEVC (and AVC) standards) may be based on interframe coding principle, although they differ in key details as needed to squeeze higher compression efficiency. Since the implementations discussed herein highly applicable to new state-of-the-art standards (e.g., such as HEVC (and AVC)), and as HEVC is a lot more complex than AVC, the framework of HEVC can be used as one example of how the implementations discussed herein might be carried out.

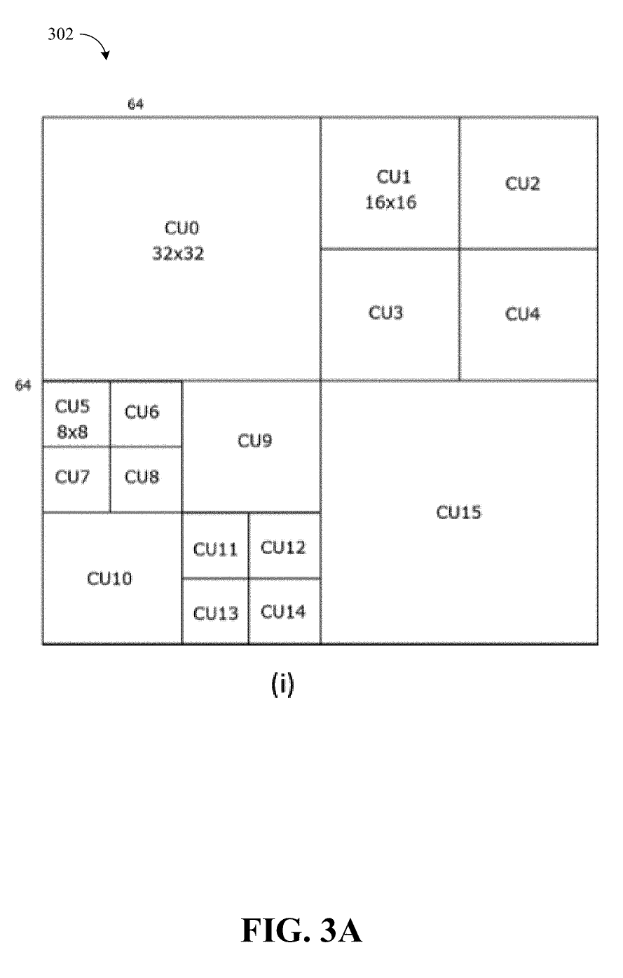

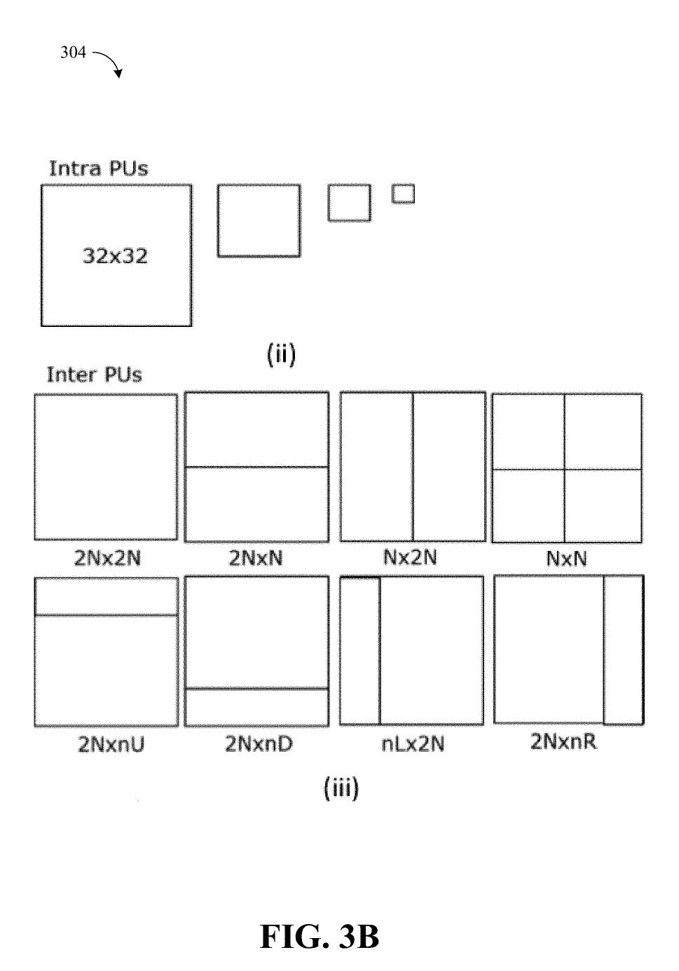

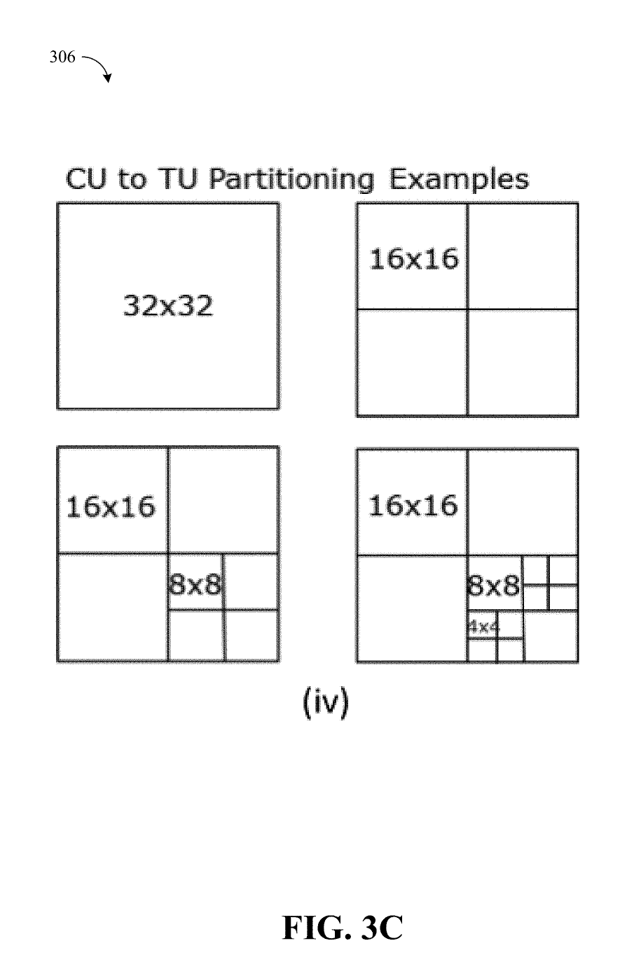

Referring to FIG. 3A, such HEVC encoding typically first divides pictures/frames of video into variable block size processing structures called coding units (CUs). HEVC is a block based predictive difference block transform coder. Input video frames are partitioned recursively from Largest Coding Units 302 (LCUs) (e.g., Coded Tree Blocks (CTBs)) to coding units (CUs), as shown in FIG. 3A. Largest Coding Units (LCUs) are square and can be of 64×64, or 32×32 or 16×16 size, with 64×64 size being quite typical. Coding units (CUs) are also square with sizes while they start from LCU size; the smallest CU size supported is 8×8.

Referring to FIG. 3B, further coding units (CUs) are non-recursively partitioned into Prediction Units 304 (PUs). When coding units (CUs) are intra the generated prediction units are square of sizes 32×32 or 16×16 or 8×8 or 4×4. Alternatively when CU's are inter, both square and rectangular PU's of size/shapes shown in FIG. 1B(iii) are allowed.

Referring to FIG. 3C, the prediction partition (PUs) are next combined to generate prediction coding units that are differenced from the original coding units resulting in residual coding units that are recursively Quad-Tree split into variable size Transform Units 306 (TUs). These Transform Units 306 (TUs) can be of sizes 32×32, or 16×16 or 8×8 or 4×4. The process of CU/residual CU to TU partitioning is shown in FIG. 3C. The size of the transform used for transform coding corresponds to the size of each transform unit, e.g., 32×32, or 16×16 or 8×8 or 4×4.

The main transform used may be integer DCT approximation with 2D separable transforms of sizes 4×4 or 8×8 or 16×16 or 32×32 possible. In addition, an alternative transform (integer DST approximation) is also available of size 4×4 for 4×4 intra CUs (e.g., 4×4 CU's can use either 4×4 DCT or 4×4 DST transforms).

Referring back to FIG. 2B, video encoder 108 may be implemented as an HEVC Encoder. The high level operation of this encoder may follow the principles of general interframe encoders discussed earlier via FIG. 2A. For instance, video encoder 108 of FIG. 2B is also an inter-frame motion compensated transform encoder that typically either uses a combination of either I- and P-pictures only or I-, P- and B-pictures (note that in HEVC a generalized B-picture (GBP) can be used in place of P-picture) in a non-pyramid, or pyramid Group of Pictures (GOP) arrangement. Further, like H.264/AVC coding, not only B-pictures (e.g., pictures that can use bi-directional references), but also P-picture can also use multiple references (e.g., these references are unidirectional for P-pictures). As in previous standards use of B-pictures implies forward and backward prediction references, and hence picture reordering is necessary.

In operation, video encoder 108 may operate so that the LCU to CU portion of prediction partitioner 244 may partition LCUs to CUs, and a CU can be recursively partitioned into smaller CUs. The CU to PU portion of prediction partitioner 244 may partitions CUs for prediction into PUs. The coding partitioner 246 may partition residual CUs into Transforms Units (TUs). TUs correspond to the size of transform blocks used in transform coding. The transform coefficients are quantized according to quantization (Qp) in bitstream. Different Qps can be specified for each CU depending on maxCuDQpDepth with LCU based adaptation being of the least granularity. In HEVC, “maxCUDQpDepth” refers to ability to specify different Qp values for different CU sizes for transform coding. For instance, Qp adaptation is possible not only on LCU (e.g. 64×64 (depth 0)) basis but also on smaller CU sizes (e.g., 32×32 (depth 1), 16×16 (depth 2), and 8×8 (depth 3)) basis as well. The encode decisions, quantized transformed difference, motion vectors and modes may be encoded in the bitstream using Context Adaptive Binary Arithmetic Coder (CABAC) an efficient entropy coder.

Encode Controller 282 may control the degree of partitioning performed, which depends on quantizer used in transform coding. The residual assembler 260 (e.g., Res TU_CU Assembler) and prediction assembler 262 (e.g., PU_CU & CU_LCU Assembler) perform the reverse function of the respective practitioners. The internally decoded intra/motion compensated difference partitions are assembled following inverse DST/DCT to which prediction PUs are added to a reconstructed signal, then deblock filtered and SAO filtered that correspondingly reduce appearance of artifacts and restore edges impacted by coding.

The illustrated HEVC-type video encoder 108 may use Intra and Inter prediction modes to predict portions of frames and encodes the difference signal by transforming it. HEVC may use various transform sizes called Transforms Units (TU). The transform coefficients may be quantized according to Qp in the bitstream. Different Qps can be specified for each CU depending on maxCuDQpDepth with LCU based adaptation being the least granularity. The encode decisions, quantized transformed difference and all the decoder required parameters may be encoded using a Context Adaptive Variable Length Coder (VLC) or Context Adaptive Binary Arithmetic Coder (CABAC).

The illustrated HEVC-type video encoder 108 may classify pictures or frames into one of 3 basic picture types (pictyp), I-Picture, P-Pictures, and B-Pictures. HEVC also allows out of order coding of B pictures, where the typical method is to encode a Group of Pictures (GOP) in out of order pyramid configuration. The typical Pyramid GOP configuration uses 8 pictures GOP size (gopsz). The out of order delay of B Pictures in the Pyramid configuration is called the picture level in pyramid (piclvl).

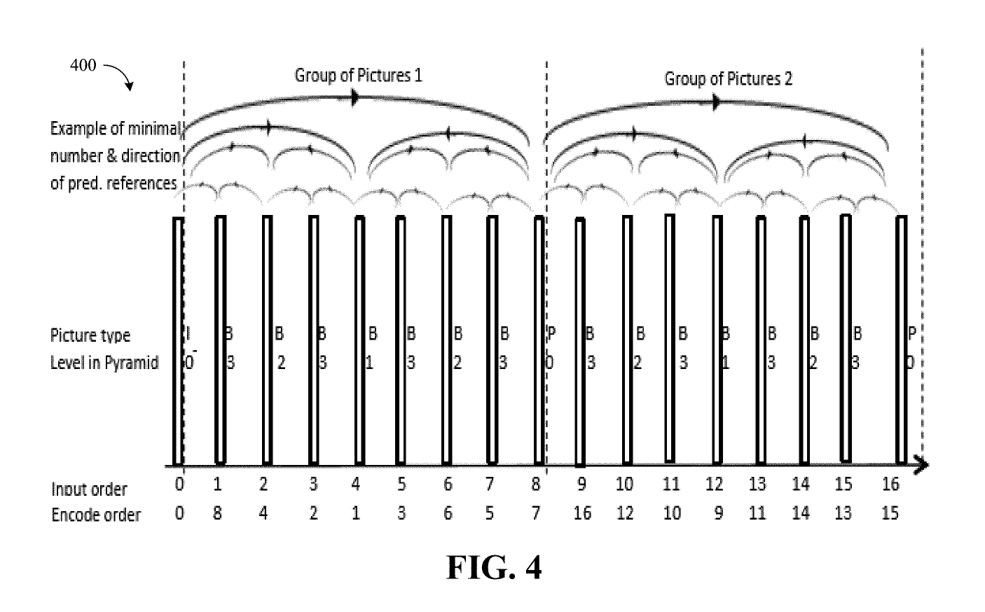

FIG. 4 shows an example Group of Pictures 400 structure. Group of Pictures 400 shows a first 17 frames (frames 0 to 16) including a first frame (frame 0) an intra frame followed by two GOPs, each with eight pictures each. In the first GOP, frame 8 is a P frame (or can also be a Generalized B (GPB) frame) and is a level 0 frame in the pyramid. Whereas frame 1 is a first level B-frame, frame 2 and 6 are second level B-frames, and frames 1, 3, 5 and 7 are all third level B-frames. For instance, frame 1 is called the first level B-frame, as it only needs the I-frame (or the last P-frame of previous GOP) as the previous reference and actual P-frame of current GOP as the next reference to create predictions necessary for encoding frame 1. In fact, frame 1 can use more than 2 references, although 2 references may be used to illustrate the principle. Further, frames 2 and 6 are called second level B-frames as they use first level B-frame (frame 1) as a reference, along with a neighboring I and P-frame. Similarly level 3 B-frames use at least one level 2 B-frame as a reference. A second GOP (frame 9 through 16) of the same size is shown, that uses decoded P-frame of previous GOP (instead of I-frame as in case of previous GOP), e.g., frame 8 as one reference; where the rest of the second GOP works identically to the first GOP. In terms of encoding order, the encoded bitstream encodes frame 0, followed by frame 8, frame 4, frame 2, frame 1, frame 3, frame 6, frame 5, frame 7, etc. as shown in the figure.

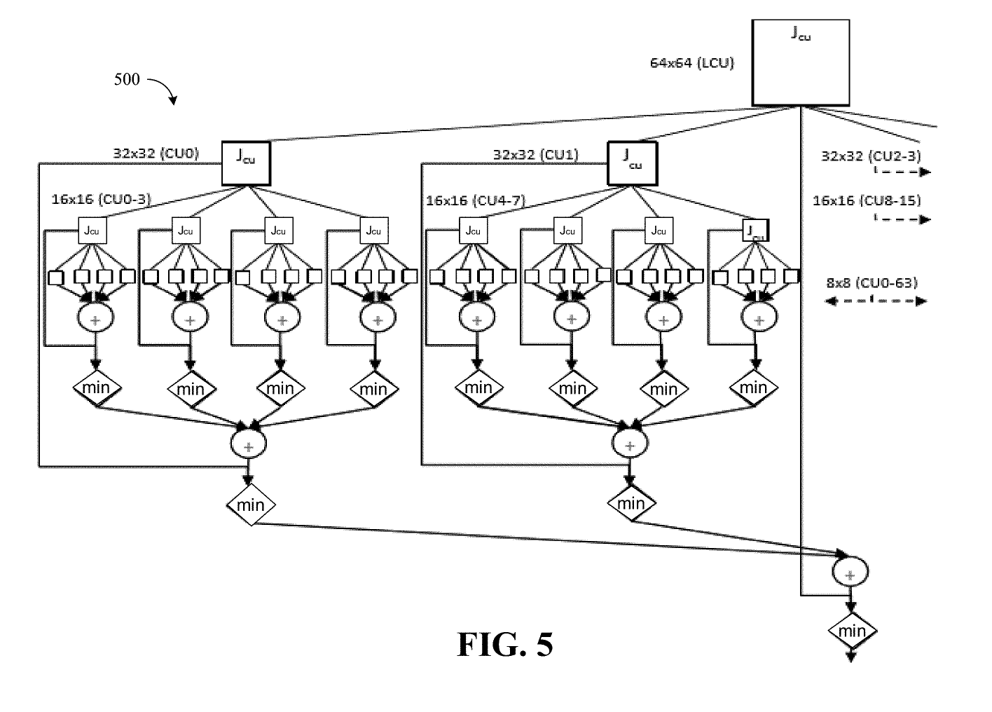

FIG. 5 illustrates a Rate Distortion optimization based pattern 500 and mode decision in HEVC type encoding. As illustrated, HEVC-type encoding may generate video bit streams such that certain compression and video quality trade-off is achieved; it tries to optimize this efficiency by achieving bitrate targets at high video quality. Bitrate is a resource, which directly affects network and/or storage capacity. In coding, quality is measured as error between compressed video and original video and typically in HEVC encoding considerable effort is placed to minimize this error, often at the expense of great computing resources. HEVC encoding involves deciding per picture, local CU sizes, prediction modes (e.g., one of various intra or inter modes), and TU sizes. The typical method of decision uses Rate Distortion optimization (RDO) with a Lagrange multiplier called Lambda, where the target is to minimize the distortion D for a given rate R by selecting the appropriate modes.

min{J} where J=D+λ·R (1)

Simple Pyramid HEVC encoding uses constant Qp for each picture. The Qp for each picture is computed from a representative Qp (QR) for the GOP and is dependent on the pictype and the piclevel of a picture within a GOP.

Brute-force RD first computes the RD cost J of encoding an LCU using each possible combination of partitioning and mode and then picks the combination that offers the minimum cost; this process is referred to as RD optimization (RDO). As noted earlier, to compute J, a distortion (e.g., a function of reconstruction error) and bit cost (R) are needed. Thus J represents an operating point, and min J represents the best operating point that offers the best tradeoff of distortion versus bits cost. The RDO process is thus quite compute intensive but can provide the best coding gains. For instance, such an RDO process is implemented by the Moving Picture Experts Group High Efficiency Video Coding reference software (MPEG HEVC HM) Encoder, which represents a close to ideal reference.

This full RDO process is pictorially shown by example in FIG. 5, and will be explained next in more detail. Each picture is partitioned into LCUs and coded LCU by LCU, assuming recursive partitioning of LCU to smallest allowed CU. For instance if LCU size is 64×64, first direct coding cost of LCU is calculated, after which each LCU is then quad-tree partitioned first into four 32×32 CUs, and direct coding cost of each 32×32 LCU is calculated. Next, each 32×32 CU is partitioned into four 16×16 CUs each and direct coding cost of each 16×16 CU is computed. This is followed by partitioning of each 16×16 CU into four 8×8 CUs (e.g., the minimum size allowed for a CU) and coding cost of each 8×8 CU is calculated. The best partitioning for an LCU is then provided by the minimum cost (J) path going through all levels of partitioning of the tree. For instance for some LCU's it may turn out that the minimum cost path is that provided by no partitioning, while for other LCUs the best path may be at 32×32 level, and others may provide the best path at 8×8 partitioning level. The main thing to note is that for each LCU, all potential partitioning paths need to be explored and cost of each partitioning combination found to get a minimum/optimal path (partitioning and mode combination) for each LCU.

So, why does the minimum cost/best path vary per LCU, in other words what does it depend on? It depends on the content (e.g., of an LCU, say, low detail, medium or high detail) as well as on the overall available bit-rate (or quantizer) for coding a frame.

Where J_{mode} is the RD cost of coding 1 mode:

J=D+λ·R (2)

And Jcu is minimum RD cost of coding the CU with the best mode:

J_{cu}=Min(Jₛₖᵢₚ,Jᵢₙₜₑᵣ,Jᵢₙₜᵣₐ) (3)

Computing RD Cost J for single CU mode involves 5 steps: 1) searching for best mode parameters; 2) partition decision for transform tree and Residual coding; 3) computing bit cost of residual coding and mode coding overhead; 4) reconstructing the final mode; and 5) computing distortion usually mean square error (recon and original). The first operation of searching for best mode parameters includes performing the following operations for intra mode find: best intra pu partition and find best intra prediction mode or direction; for inter mode find: best inter pu partition, best (uni/bi) prediction mode, best merge candidate, and best reference frames; for skip find: best candidate.

Lastly, Jctu is a minimum RD cost of coding the Coding Tree Unit (CTU) with best split (split or not split decision):

J_{ctu}=Min(J_{cu},sumofsplits(J_{cu})) (4)

Often the term CTU and Largest Coding Unit (LCU) may be used interchangeably to refer to a 64×64 size CU that is often the starting basis for partitioning for prediction and coding.

FIG. 6 illustrates an offline training system 600, arranged in accordance with at least some implementations of the present disclosure. In various implementations, offline training system 600 may include an optimal video encoder 602, a Content Analyzer & Features Generator 604 (CAFG), a features and optimal decisions database 606, and an offline parameter optimization 608. Content Analyzer & Features Generator 604 will be described in greater detail below with regard to several implementations described herein.

In operation, offline training system 600 may input a pre-determined collection of training videos and encode the training videos with an ideal reference encoder to determine ideal mode and partitioning decisions based at least in part on one or more of the following: a plurality of fixed quantizers, a plurality of fixed data-rates, and a plurality of group of pictures structures. Offline training system 600 may calculate spatial metrics and temporal metrics that form the corresponding spatial features and temporal features, based at least in part on the training videos. Additionally, offline training system 600 may determine weights, exponents, and thresholds for intelligent encoding functions (IEF) such that prediction of an ideal mode and partitioning decisions using the obtained spatial metrics and temporal metrics by calculating the intelligent encoding functions (IEF) is maximized.

In the training process, a large collection of video content, referred to as vidtraincont, may be analyzed by Content Analyzer & Features Generator 604 to compute its spatial and temporal features. Also, in parallel, the content is encoded by optimal video encoder 602 (e.g., a high quality encoder, for instance for HEVC an MPEG committee's HM Encoder may be used that makes ideal decision but is super slow) and the ideal decisions and the calculated features are stored in features and optimal decisions database 606 and are correlated in offline parameter optimization 608 that computes and outputs spatial-temporal complexity (STC) parameters, feature weights, and thresholds of intelligent encoder functions (IEF), all of which will be described in greater detail below.

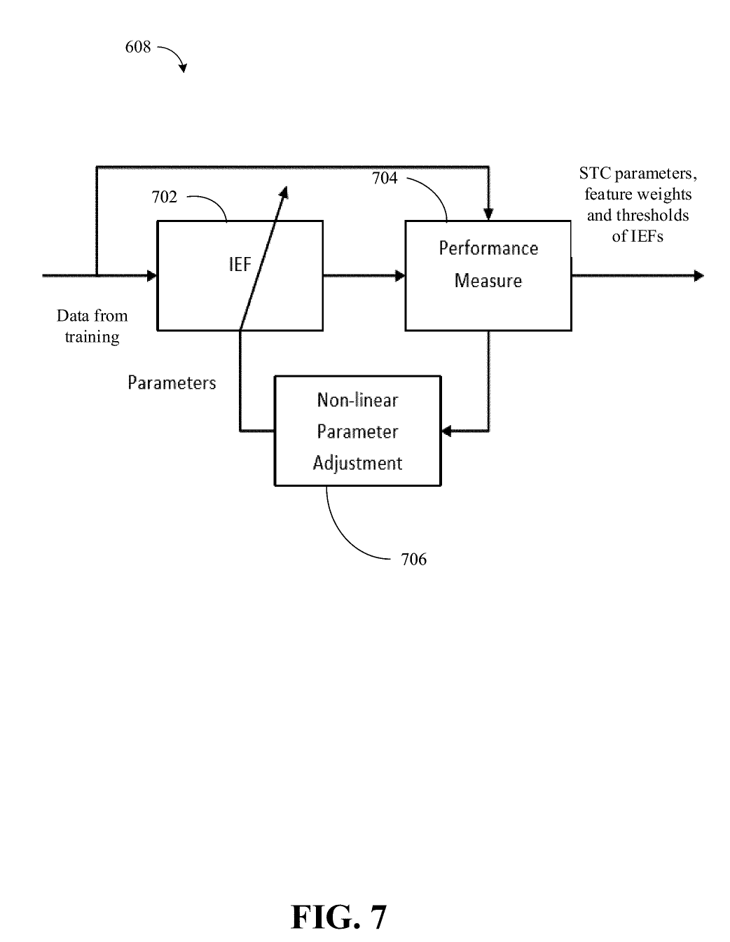

FIG. 7 illustrates the offline parameter optimization 608, arranged in accordance with at least some implementations of the present disclosure. In various implementations, offline parameter optimization 608 may include intelligent encoder functions 702 (IEFs), a performance measurement unit 704, and a non-linear parameter adjustment unit 706. The non-linear parameter adjustment unit 706 may determine best parameters to control intelligent encoder functions 702 (IEFs). CAFG features such spatial complexity and spatial-temporal complexity curves may be good classifiers of complexity and predictability and may be used as features for classification. HEVC mode and split decisions may be posed as binary classification problems with known ground truth results from an optimal HEVC encoder (HM). Classifiers based on parameterized features are optimized to maximize classification metric Fbeta. Non-linear unconstrained iterative optimizers, (e.g., such as fminsearch) may be used find optimal parameters. The classification performance metric Fbeta-score may be maximized for the training set. Beta may be chosen to provide precision or sensitivity as needed per the classifier and for speed/quality tradeoff as per codec. Parameters may be binned for various codec operating points, such as Qp and P/B Frame type and hierarchy, for example.

The following intelligent encoder functions 702 (IEFs) may be trained on the following features, where a Mode Subset Decider uses the following Mode IEFs: Force_Intra (FI), where blocks identified by this IEF should be intra coded; Try_Intra (TI), where blocks identified by this IEF should be tested for Intra coding; and Disable_Skip (DS), where blocks identified by this IEF should not use Skip mode coding. Similarly, the following intelligent encoder functions 702 (IEFs) may be trained on the following features, where a Split Subset Decider uses the following Split IEFs: Not_Split (NS), where blocks identified by this IEF should not be split; and Force_Split (FS), where blocks identified by this IEFs should be split.

IEF parameters may be derived and binned for multiple codec operating conditions including: frame level, Qr (e.g., the representative Qp for the entire group of pictures pyramid), and/or CU size. For example, the frame level may indicate P (or GBP), B1, B2, or B3 frame level. Likewise, Qr may be binned for values less than or equal to 22, between 23 and 27, between 28 and 32, between 33 and 38, and greater than 38, although this is just one example. Similarly CU size may indicate a 64×64 size, a 32×32 size, or a 16×16 size.

As mentioned above, the Qr is the representative Qp for the entire group of pictures (GOP) pyramid. The true Qp for a frame-type/picture level (piclvl) is typically computed as show in table below. If Qr is not available for example in bitrate control mode, the Qr may be inversely computed from Frame/slice Qp from Table 1. Table 1 shows an example of a typically useful Quantizer assignments to I, P, and B-frames.

TABLE 1

| FrameType-Piclvl | Frame/Slice Qp |
|---|---|
| I | Qr − 1 |
| P | Qr |
| B1 | Qr + 1 |
| B2 | Qr + 2 |
| B3 | Qr + 3 |

Performance Measure

In statistical analysis of binary classification, the Fβ score (also F-score or F-measure) is a measure of a test's accuracy. It considers both the precision p and the sensitivity or recall r of the test to compute the score where p is the number of correct positive results divided by the number of all positive results, and r is the number of correct positive results divided by the number of positive results that should have been returned.

The Fβ score can be interpreted as harmonic mean of the precision and recall, where an Fβ score reaches its best value at 1 and worst at 0.

Such statistical scores and IEF equations are listed below, for example:

Statistical Scores:

Sensitivity or Recall=r=TPR (True Positive Rate)=(True Positives)/(Positive Instances) (5)

Precision=p=PPV (Positive Predictive Value)=(True Positives)/(Positive Predictions) (6)

F_{β}=(1+β²)*r*p/(r+β²*p) (7)

IEF Equations:

Force Intra IEF

Fi=X(SCpp>a)·X(SADpp>αSCpp^{β}+γmvd)·X(mvd>b) (8)

Try Intra IEF

Ti=X(SADpp>αSCpp^{β}+γmvd) (9)

Disable Skip IEF

Ds=X(SADpp<α2^{(Qp-4)/6})·X(mvd<b) (10)

Force Split IEF

Fs=X(SCpp>a)·X(SADpp>αSCpp^{β})·X(SADred<c)·X(SADvar<d)+X(SCvar>Tsc) (11)

Not Split IEF

Ns=X(SCpp<a)·X(SADpp>α)·X(SADred>c)·X(SADvar>d) (12)

Where “X” is decision step function which return 1 for true and 0 for false condition.

The following tables, Tables 2-8, illustrate various parameter bins that may be used with the IEF equations above.

Parameter Bins:

TABLE 2
Parameter Bins based on Cusz, Piclvl and Qr

| | | | | | |
|---|---|---|---|---|---|
| Frametype, | | | | | |
| Piclvl | Qr < 23 | Qr < 28 | Qr < 33 | Qr < 39 | Qr >= 39 |

Cusz = 64 × 64

| | | | | | |
|---|---|---|---|---|---|
| P Frame | ParamSet0 | ParamSet0 | ParamSet0 | ParamSet0 | ParamSet0 |
| | [0,0] | [0,1] | [0,2] | [0,3] | [0,4] |
| B1 Frame | ParamSet0 | ParamSet0 | ParamSet0 | ParamSet0 | ParamSet0 |
| | [1,0] | [1,1] | [1,2] | [1,3] | [1,4] |
| B2 Frame | ParamSet0 | ParamSet0 | ParamSet0 | ParamSet0 | ParamSet0 |
| | [2,0] | [2,1] | [2,2] | [2,3] | [2,4] |
| B3 Frame | ParamSet0 | ParamSet0 | ParamSet0 | ParamSet0 | ParamSet0 |
| | [3,0] | [3,1] | [3,2] | [3,3] | [3,4] |

Cusz = 32 × 32

| | | | | | |
|---|---|---|---|---|---|
| P Frame | ParamSet1 | ParamSet1 | ParamSet1 | ParamSet1 | ParamSet1 |
| | [0,0] | [0,1] | [0,2] | [0,3] | [0,4] |
| B1 Frame | ParamSet1 | ParamSet1 | ParamSet1 | ParamSet1 | ParamSet1 |
| | [1,0] | [1,1] | [1,2] | [1,3] | [1,4] |
| B2 Frame | ParamSet1 | ParamSet1 | ParamSet1 | ParamSet1 | ParamSet1 |
| | [2,0] | [2,1] | [2,2] | [2,3] | [2,4] |
| B3 Frame | ParamSet1 | ParamSet1 | ParamSet1 | ParamSet1 | ParamSet1 |
| | [3,0] | [3,1] | [3,2] | [3,3] | [3,4] |

Cusz =16 × 16

| | | | | | |
|---|---|---|---|---|---|
| P Frame | ParamSet2 | ParamSet2 | ParamSet2 | ParamSet2 | ParamSet2 |
| | [0,0] | [0,1] | [0,2] | [0,3] | [0,4] |
| B1 Frame | ParamSet2 | ParamSet2 | ParamSet2 | ParamSet2 | ParamSet2 |
| | [1,0] | [1,1] | [1,2] | [1,3] | [1,4] |
| B2 Frame | ParamSet2 | ParamSet2 | ParamSet2 | ParamSet2 | ParamSet2 |
| | [2,0] | [2,1] | [2,2] | [2,3] | [2,4] |
| B3 Frame | ParamSet2 | ParamSet2 | ParamSet2 | ParamSet2 | ParamSet2 |
| | [3,0] | [3,1] | [3,2] | [3,3] | [3,4] |

Cusz = 8 × 8

| | | | | | |
|---|---|---|---|---|---|
| P Frame | ParamSet3 | ParamSet3 | ParamSet3 | ParamSet3 | ParamSet3 |
| | [0,0] | [0,1] | [0,2] | [0,3] | [0,4] |
| B1 Frame | ParamSet3 | ParamSet3 | ParamSet3 | ParamSet3 | ParamSet3 |
| | [1,0] | [1,1] | [1,2] | [1,3] | [1,4] |
| B2 Frame | ParamSet3 | ParamSet3 | ParamSet3 | ParamSet3 | ParamSet3 |
| | [2,0] | [2,1] | [2,2] | [2,3] | [2,4] |
| B3 Frame | ParamSet3 | ParamSet3 | ParamSet3 | ParamSet3 | ParamSet3 |
| | [3,0] | [3,1] | [3,2] | [3,3] | [3,4] |

For example, best parameters for the above bins may be estimated by finding the maximum of performance measure Fp using unconstrained multivariable derivative-free optimization (matlab/octave fminsearch). The beta used in given in table below. Not all parameter bins are uniquely used by all IEFs and may be be merge to have less bins.

TABLE 3
β Values That Work Best for Different Proposed IEF's

| IEF | β |
|---|---|
| Force Intra | 0.25 |
| Try_Intra | 2.5 |
| Disable_Skip | 0.125 |
| Not_Split | 0.125 |
| Force_Split | 0.25 |
| Force_Split_{(64 × 64 non ref)} | 0.5 |

Try Intra IEF Parameters

As shown in Equation 9, the Try intra IEF uses features SCpp, SADpp, & mvd, and parameters (α, β, γ). The SADpp used in Try Intra IEF derived from sum of 16×16 bestSADs for CUsz>16. Similarly mvd for CUsz>16 is the average mvd of 16×16 blocks within that CU.

TABLE 4
α, β, and γ parameters as a function of frame type, cu size, and
quantizer for Try Intra IEF

| | | | | | |
|---|---|---|---|---|---|
| Frame- | | | | | |
| type, | | | | | |
| Piclvl | Qr < 23 | Qr < 28 | Qr < 33 | Qr < 39 | Qr >= 39 |

α Parameter
Cusz = 64 × 64, 32 × 32, 16 × 16, 8 × 8

| | | | | | |
|---|---|---|---|---|---|
| P | 1.321010164 | 1.549123551 | 1.874341412 | 1.991369826 | 1.991369826 |
| Frame | | | | | |
| B1 | 1.511935971 | 1.370175418 | 1.691673114 | 1.871407676 | 1.871407676 |
| Frame | | | | | |
| B2 | 1.529101610 | 1.440945215 | 1.729969737 | 1.832567641 | 1.832567641 |
| Frame | | | | | |
| B3 | 1.678588519 | 1.863436695 | 1.855189131 | 1.739090170 | 1.739090170 |
| Frame | | | | | |

β Parameter
Cusz = 64 × 64, 32 × 32, 16 × 16, 8 × 8

| | | | | | |
|---|---|---|---|---|---|
| P | 0.224284713 | 0.225156759 | 0.228965475 | 0.244476615 | 0.244476615 |
| Frame | | | | | |
| B1 | 0.233920551 | 0.281690218 | 0.276006317 | 0.308718515 | 0.308718515 |
| Frame | | | | | |
| B2 | 0.242109300 | 0.286191972 | 0.302634517 | 0.324379943 | 0.324379943 |
| Frame | | | | | |
| B3 | 0.265764491 | 0.279662270 | 0.336253831 | 0.378375619 | 0.378375619 |
| Frame | | | | | |

γ Parameter
Cusz =64 × 64, 32 × 32, 16 × 16, 8 × 8

| | | | | | |
|---|---|---|---|---|---|
| P | 0.295610 | 0.201050 | 0.177870 | 0.146770 | 0.146770 |
| Frame | | | | | |
| B1 | 0.218830 | 0.177870 | 0.146770 | 0.063581 | 0.063581 |
| Frame | | | | | |
| B2 | 0.089055 | 0.028076 | 0.028076 | 0.028076 | 0.028076 |
| Frame | | | | | |
| B3 | 0.049053 | 0.025316 | 0.023686 | 0.012673 | 0.012673 |
| Frame | | | | | |

Force Intra IEF Parameters

As shown in Equation 8, Force intra IEF uses features SCpp, SADpp, & mvd, along with parameters (a, α, β, γ, b). The SADpp used in Force Intra IEF is derived from sum of 16×16 bestSADs for CUsz>16. Similarly mvd for CUsz>16 is the average mvd of 16×16 blocks within that CU. B3 frames are low cost and low quality frames and typically fast encoder do not allow intra coding for B3 frames. For fast encoders thus Intra_only subset is not allowed for B3 frames. Table 5 below was used for a fast encoder and Force Intra IEF was not trained for B3 frames. For high quality encoder, different training may be done using the training methodology described above.

TABLE 5
a, α, β, γ, and b parameters as a function of frame type, cu size, and
quantizer for Force Intra IEF

| | | | | | |
|---|---|---|---|---|---|
| Frametype, | | | | | |
| Piclvl | Qr < 23 | Qr < 28 | Qr < 33 | Qr < 39 | Qr >= 39 |

α Parameter
Cusz = 64 × 64, 32 × 32, 16 × 16, 8 × 8

| | | | | | |
|---|---|---|---|---|---|
| P Frame | 20 | 20 | 20 | 20 | 20 |
| B1 Frame | 77.15 | 89.805 | 89.805 | 249.454 | 249.454 |
| B2 Frame | 142.184 | 142.184 | 249.454 | 249.454 | 249.454 |

α Parameter
Cusz = 64 × 64, 32 × 32, 16 × 16, 8 × 8

| | | | | | |
|---|---|---|---|---|---|
| P Frame | 1.729077 | 1.772433 | 1.969857 | 2.214098 | 2.214098 |
| B1 Frame | 1.022681 | 1.04247 | 1.225304 | 1.257329 | 1.257329 |
| B2 Frame | 1.604949 | 1.695075 | 1 | 1 | 1 |

β Parameter
Cusz = 64 × 64, 32 × 32, 16 × 16, 8 × 8

| | | | | | |
|---|---|---|---|---|---|
| P Frame | 0.303627 | 0.315012 | 0.315445 | 0.31435 | 0.31435 |
| B1 Frame | 0.423133 | 0.435791 | 0.443448 | 0.45655 | 0.45655 |
| B2 Frame | 0.397384 | 0.397396 | 0.5 | 0.5 | 0.5 |

γ Parameter
Cusz = 64 × 64, 32 × 32, 16 × 16, 8 × 8

| | | | | | |
|---|---|---|---|---|---|
| P Frame | 0.003458 | 0.006642 | 0.006441 | 0.010107 | 0.010107 |
| B1 Frame | 0.013396 | 0.013410 | 0.013410 | 0.137010 | 0.137010 |
| B2 Frame | 0.013396 | 0.013410 | 0.013410 | 0.137010 | 0.137010 |

b Parameter
Cusz = 64 × 64, 32 × 32, 16 × 16, 8 × 8

| | | | | | |
|---|---|---|---|---|---|
| P Frame | 2.5878400 | 6.8723200 | 7.2392960 | 7.6463360 | 7.6463360 |
| B1 Frame | 7.2789760 | 7.2789760 | 7.2789760 | 9.9616000 | 9.9616000 |
| B2 Frame | 10.856256 | 10.856256 | 10.856256 | 10.856256 | 10.856256 |

Disable Skip IEF Parameters

As shown in Equation 10, Force intra IEF may use features SADpp, & mvd, along with parameters (α, b). Skip blocks are characterized by no coefficients and motion vector delta. The SADpp used for CUsz>16 may be the max of 16×16 bestSADs within the CU, this helps to better model zero coefficients as transform sizes are usually smaller than CU sizes. The mvd for CUsz>16 may be the average mvd of 16×16 blocks within that CU. Both (α, b) are constants in this IEF and set to (0.186278, 4).

Split IEFs

Split IEF uses features SCpp, SADpp, mvd, SADred, and SADvar along with parameters (a, α, β, c, d). There is no 8×8 split IEF as 8×8 CU cannot be split in HEVC.

Force Split IEF Parameters

As shown in Equation 11, Force split IEF uses (a, α, β, c, d). Below are the trained parameters for various parameter bins.

TABLE 6A
a, α, β, c, and d parameters for 64 × 64 CU size as a function of
frame type, and quantizer for Force Split IEF

| | | | | | |
|---|---|---|---|---|---|
| Frametype, | | | | | |
| Piclvl | Qr < 23 | Qr < 28 | Qr < 33 | Qr < 39 | Qr >= 39 |

α Parameter
Cusz = 64 × 64

| | | | | | |
|---|---|---|---|---|---|
| P Frame | 35.83437 | 35.83437 | 53.15397 | 84.65527 | 84.65527 |
| B1 Frame | 35.83437 | 35.83437 | 53.15397 | 101.5887 | 101.5887 |
| B2 Frame | 41.05958 | 92.4443 | 92.4443 | 153.4373 | 153.4373 |
| B3 Frame | 41.05958 | 92.4443 | 145.323 | 153.4373 | 153.4373 |

α Parameter
Cusz = 64 × 64

| | | | | | |
|---|---|---|---|---|---|
| P Frame | 0.006726 | 0.279017 | 0.479557 | 0.656086 | 0.656086 |
| B1 Frame | 0.065518 | 0.467707 | 1.06171 | 1.127229 | 1.127229 |
| B2 Frame | 0.138288 | 0.524795 | 1.127229 | 1.050047 | 1.050047 |
| B3 Frame | 0.311087 | 1.17516 | 1.20668 | 1.215724 | 1.215724 |

β Parameter
Cusz = 64 × 64

| | | | | | |
|---|---|---|---|---|---|
| P Frame | 0.201753 | 0.201753 | 0.22069 | 0.22069 | 0.22069 |
| B1 Frame | 0.206216 | 0.202816 | 0.22069 | 0.22069 | 0.22069 |
| B2 Frame | 0.206216 | 0.202816 | 0.22069 | 0.259862 | 0.259862 |
| B3 Frame | 0.206216 | 0.216511 | 0.256019 | 0.259862 | 0.259862 |

c Parameter
Cusz = 64 × 64

| | | | | | |
|---|---|---|---|---|---|
| P Frame | 0.912122 | 0.935644 | 0.975582 | 0.975582 | 0.975582 |
| B1 Frame | 0.88504 | 0.88504 | 0.910311 | 0.910311 | 0.910311 |
| B2 Frame | 0.880658 | 0.880658 | 0.895107 | 0.895107 | 0.895107 |
| B3 Frame | 0.839305 | 0.839305 | 0.839305 | 0.839305 | 0.839305 |

d Parameter
Cusz = 64 × 64

| | | | | | |
|---|---|---|---|---|---|
| P Frame | 0.908454 | 0.908454 | 0.761493 | 0.761493 | 0.761493 |
| B1 Frame | 0.73001 | 0.736458 | 0.657742 | 0.657742 | 0.657742 |
| B2 Frame | 0.73001 | 0.680618 | 0.657742 | 0.645925 | 0.645925 |
| B3 Frame | 0.587394 | 0.587394 | 0.587394 | 0.489023 | 0.489023 |

TABLE 6B
a, α, β, c, and d parameters for 32 × 32 and 16 × 16 CU size as a
function of frame type, and quantizer for Force Split IEF

| | | | | | |
|---|---|---|---|---|---|
| Frametype, | | | | | |
| Piclvl | Qr < 23 | Qr < 28 | Qr < 33 | Qr < 39 | Qr >= 39 |

α Parameter
Cusz = 32 × 32, 16 × 16

| | | | | | |
|---|---|---|---|---|---|
| P Frame | 35.83437 | 35.83437 | 53.15397 | 84.65527 | 84.65527 |
| B1 Frame | 35.83437 | 35.83437 | 53.15397 | 101.5887 | 101.5887 |
| B2 Frame | 41.05958 | 92.4443 | 92.4443 | 153.4373 | 153.4373 |
| B3 Frame | 41.05958 | 92.4443 | 145.323 | 153.4373 | 153.4373 |

α Parameter
Cusz = 32 × 32, 16 × 16

| | | | | | |
|---|---|---|---|---|---|
| P Frame | 1.278444 | 1.278444 | 1.384332 | 0.834697 | 0.834697 |
| B1 Frame | 0.607073 | 0.607073 | 0.663312 | 0.663312 | 0.663312 |
| B2 Frame | 0.607073 | 0.607073 | 0.559499 | 0.559499 | 0.559499 |
| B3 Frame | 0.607073 | 0.607073 | 0.559499 | 0.559499 | 0.559499 |

β Parameter
Cusz = 32 × 32, 16 × 16

| | | | | | |
|---|---|---|---|---|---|
| P Frame | 0.287202 | 0.287202 | 0.298285 | 0.402038 | 0.402038 |
| B1 Frame | 0.403360 | 0.403360 | 0.428807 | 0.428807 | 0.428807 |
| B2 Frame | 0.403360 | 0.403360 | 0.433341 | 0.433341 | 0.433341 |
| B3 Frame | 0.403360 | 0.403360 | 0.433341 | 0.433341 | 0.433341 |

c Parameter
Cusz = 32 × 32, 16 × 16

| | | | | | |
|---|---|---|---|---|---|
| P Frame | 0.912122 | 0.935644 | 0.975582 | 0.975582 | 0.975582 |
| B1 Frame | 0.88504 | 0.88504 | 0.910311 | 0.910311 | 0.910311 |
| B2 Frame | 0.880658 | 0.880658 | 0.895107 | 0.895107 | 0.895107 |
| B3 Frame | 0.839305 | 0.839305 | 0.839305 | 0.839305 | 0.839305 |

d Parameter
Cusz = 32 × 32, 16 × 16

| | | | | | |
|---|---|---|---|---|---|
| P Frame | 0.587745 | 0.587745 | 0.522034 | 0.506323 | 0.506323 |
| B1 Frame | 0.526156 | 0.526156 | 0.481829 | 0.481829 | 0.481829 |
| B2 Frame | 0.516603 | 0.516603 | 0.481829 | 0.481829 | 0.481829 |
| B3 Frame | 0.516603 | 0.516603 | 0.481829 | 0.481829 | 0.481829 |

TABLE 7
TSC parameter as a function of SCpp for different CU sizes
Tsc Parameter
Cusz = 64 × 64, 32 × 32, 16 × 16

| Mode | | | | | | | | | |
|---|---|---|---|---|---|---|---|---|---|
| subset | SCpp < 16 | SCpp < 81 | SCpp < 225 | SCpp < 529 | SCpp < 1024 | SCpp < 1764 | SCpp < 2809 | SCpp < 4225 | SCpp >= 4225 |
| Intra_ | 10 | 39 | 81 | 168 | 268 | 395 | 553 | 744 | 962 |
| Only | | | | | | | | | |
| Inter_ | | | | | | | | | |
| Intra | | | | | | | | | |
| Inter | SC_MAX | SC_MAX | SC_MAX | SC_MAX | SC_MAX | SC_MAX | SC_MAX | SC_MAX | SC_MAX |
| Only | | | | | | | | | |
| Inter_ | | | | | | | | | |
| Skip | | | | | | | | | |

Please note that *SC_MAX (Inter Force Split IEF) does not use TSc or SCvar parameter.

Not Split IEF Parameters

As shown in Equation 12, Not Split IEF uses (a, α, c, d). Below are the trained parameters for various bins.

TABLE 8
a, α, c, and d parameter as a function of frame type, CU size and
quantizer for not Split IEF
a Parameter
Cusz = 64 × 64, 32 × 32, 16 × 16

| Frametype, | | | | | |
|---|---|---|---|---|---|
| Piclvl | Qr < 23 | Qr < 28 | Qr < 33 | Qr < 39 | Qr >= 39 |
| P Frame | 10.82573 | 22.45807 | 120.7993 | 216.0568 | 216.0568 |
| B1 Frame | 22.45807 | 22.45807 | 120.7993 | 216.0568 | 216.0568 |
| B2 Frame | 22.45807 | 22.45807 | 120.7993 | 216.0568 | 216.0568 |
| B3 Frame | 22.45807 | 22.45807 | 120.7993 | 216.0568 | 216.0568 |

α Parameter
Cusz = 64 × 64, 32 × 32, 16 × 16

| Frametype, | | | | | |
|---|---|---|---|---|---|
| Piclvl | Qr < 23 | Qr < 28 | Qr < 33 | Qr < 39 | Qr >= 39 |
| P Frame | 0.589993 | 0.589993 | 0.821366 | 0.914416 | 0.914416 |
| B1 Frame | 0.589993 | 0.589993 | 0.821366 | 0.914416 | 0.914416 |
| B2 Frame | 0.589993 | 0.589993 | 0.821366 | 0.914416 | 0.914416 |
| B3 Frame | 0.589993 | 0.589993 | 0.821366 | 0.914416 | 0.914416 |

c Parameter
Cusz = 64 × 64, 32 × 32, 16 × 16

| Frametype, | | | | | |
|---|---|---|---|---|---|
| Piclvl | Qr < 23 | Qr < 28 | Qr < 33 | Qr > 33 | Qr >= 39 |
| P Frame | 0.991 | 0.991 | 0.991 | 0.991 | 0.991 |
| B1 Frame | 0.991 | 0.991 | 0.991 | 0.991 | 0.991 |
| B2 Frame | 0.991 | 0.991 | 0.991 | 0.991 | 0.991 |
| B3 Frame | 0.975 | 0.975 | 0.975 | 0.972 | 0.972 |

d Parameter
Cusz = 64 × 64, 32 × 32

| Frametype, | | | | | |
|---|---|---|---|---|---|
| Piclvl | Qr < 23 | Qr < 28 | Qr < 33 | Qr < 39 | Qr >= 39 |
| P Frame | 0.669666 | 0.669666 | 0.669666 | 0.669666 | 0.669666 |
| B1 Frame | 0.669666 | 0.669666 | 0.669666 | 0.669666 | 0.669666 |
| B2 Frame | 0.669666 | 0.669666 | 0.669666 | 0.669666 | 0.669666 |
| B3 Frame | 0.669666 | 0.669666 | 0.669666 | 0.669666 | 0.669666 |

d Parameter
Cusz = 16 × 16

| Frametype, | | | | | |
|---|---|---|---|---|---|
| Piclvl | Qr < 23 | Qr < 28 | Qr < 33 | Qr < 39 | Qr >= 39 |
| P Frame | 0.755 | 0.755 | 0.755 | 0.755 | 0.755 |
| B1 Frame | 0.755 | 0.755 | 0.755 | 0.755 | 0.755 |
| B2 Frame | 0.755 | 0.755 | 0.755 | 0.755 | 0.755 |
| B3 Frame | 0.755 | 0.755 | 0.755 | 0.755 | 0.755 |

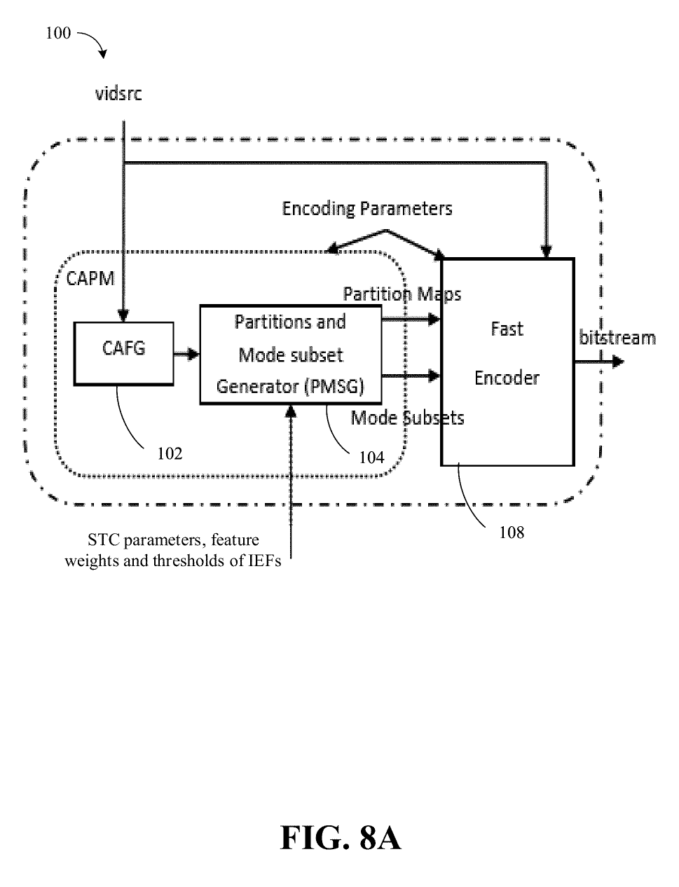

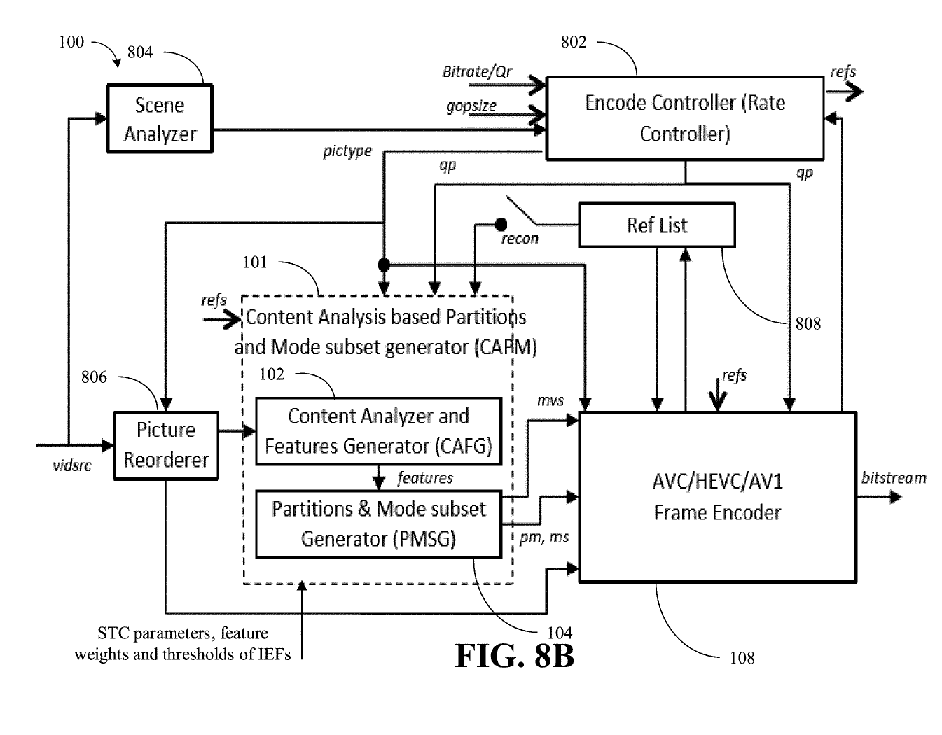

FIG. 8A is an illustrative block diagram of a learning driven fast video encoding implementation of the partition and mode simplification system 100, arranged in accordance with at least some implementations of the present disclosure. In various implementations, partition and mode simplification system 100 may include content analyzer based partitions and mode subset generator (CAPM) system 101. Content analyzer based partitions and mode subset generator (CAPM) system 101 may use content analyzer and features generator (CAFG) 102 and partitioning and mode subsets generator (PMSG) 104, as described above, with reference to FIG. 1.

In the illustrated example, content analyzer based partitions and mode subset generator (CAPM) system 101 may utilize the results of training at the time of actual encoding. Basically, FIG. 8A shows a fast, yet high encoded video quality system that is based on FIG. 1 such as when FIG. 1 employs ‘learning’ as basis for ‘partitions and modes selection.’ For example, FIG. 6 shows operation of an offline learning based system that uses ideal encoding (e.g., using HEVC HM) to generate optimal partitioning and mode decisions for input video training content (vidtraincont). In parallel, the video training content is also input to content analyzer and features generator (CAFG) 102, which analyzes the content to generate features from it. These operations are performed on a large collection of video training content and the generated features and optimal decisions from training are stored in Features & Optimal Decisions Database 606 (see, e.g., FIG. 6). Next, the training data is input to offline parameter optimization 608 (see, e.g., FIG. 6) process that computes and outputs spatial-temporal complexity (STC) parameters, feature weights and thresholds of Intelligent Encoding Functions (IEFs). This enables the overall encoder (e.g., a AVC, HEVC, or AV1 encoder) to have improve processing speed under the control of parameters, feature weights and thresholds from offline training. As used herein, the term “fast encoder,” “fast video encoder,” or the like, refers to such an implementation, where fast video encoder 108 (e.g., a AVC, HEVC, or AV1 encoder) has improved processing speed under the control of parameters, feature weights and thresholds from offline training.

FIG. 8B is another illustrative block diagram of the partition and mode simplification system 100, arranged in accordance with at least some implementations of the present disclosure. FIG. 8B shows a more detailed view of the partition and mode simplification system 100, which was presented at a higher level in FIG. 8A. Both FIG. 8A and FIG. 8B show feature generation via content analyzer and features generator (CAFG) 102, which is the same or similar operation as shown in FIG. 6, albeit FIG. 6 performs these operations all on training content, whereas in FIG. 8B these operations are performed only on content to be encoded. For example, FIG. 8B employs offline generated optimized data from training (e.g. STC parameters, feature weights and thresholds of IEFs from FIG. 6) to choose small number of candidate mode subsets and partitioning maps, in not only fast but also accurate manner.

In some implementations, the partition and mode simplification system 100 may include content analyzer based partitions and mode subset generator (CAPM) system 101. Content analyzer based partitions and mode subset generator (CAPM) system 101 may include the content analyzer and features generator (CAFG) 102 and partitions and mode subset generator (PMSG) 104, content analyzer and features generator (CAFG) 102 may determine a plurality of spatial features and temporal features for a current largest coding unit of a current frame of the video sequence.

Partitions and mode subset generator (PMSG) 104 may determine a limited number of partition maps and a limited number of mode subsets for the current largest coding unit of the current frame based at least in part on the spatial features and temporal features.

An encode controller 802 (also referred to herein as a rate controller or coder controller) of a video coder may be communicatively coupled to the content analyzer based partitions and mode subset generator (CAPM) system 101. Encode controller 802 may perform rate distortion optimization operations during coding of the video sequence, where the rate distortion optimization operations have a limited complexity based at least in part on the limited number of partition maps and the limited number of mode subsets. For example, the Rate-Distortion (RD) computation operations may us fewer modes and partitions, as compared with full RDO optimization operations, due to smart pre-analysis that is driven by training data to get a significant speedup in Rate-Distortion (RD) computation operations. Additionally or alternatively, another simplification may include choosing a good enough candidate (e.g., not the best candidate) during the Rate-Distortion (RD) computation operations.

In operation, video to be encoded (vidsrc) may be is input to scene analyzer 804. Scene analyzer 804 may analyze the input scene for scene changes and provides this info to encode controller 802. Encode controller 802 may also receive as input either the bitrate (for fixed bitrate based coding) or the representative quantizer (Qr for fixed quantizer based coding), a size of group of pictures (gopsize) to use, and encode buffer fullness. Encode controller 802 makes critical encoding decisions as well as performs rate control; specifically, it determines the picture type (pictype) of frame to be encoded, which references (refs) should be used for encoding it, and the quantizer (qp) to be used for encoding. The picture type (pictype) decided by encode controller 802 is used by picture reorderer 806. Picture reorderer 806 may receive video to be encoded (vidsrc) frames, and, in case of B-pictures, needs to reorder frames as they are non-causal and require both backward and forward references for prediction. If frame being coded is assigned picture type of I- or P-picture, no such reordering is necessary.

The reordered (if needed) pictures at the output of Picture Reorderer 806, pictype, qp, and reconstructed frames stored in Ref List (e.g., which may be indexed by refs) are input to content analyzer based partitions and mode subset generator (CAPM) system 101, which as discussed earlier mainly includes the content analyzer and features generator (CAFG) 102 and partitions and mode subset generator (PMSG) 104. Content analyzer based partitions and mode subset generator (CAPM) system 101 may operate with access to only source video as a completely independent pre-analysis module; however, for faster and better results it is best to use the reconstructed reference frame from the ref list. In some situations, the content analyzer and features generator (CAFG) 102 may use Reconstructed Reference frames for motion estimation (e.g., as may be supplied via the illustrated “recon” switch), which may provide better compression efficiency and also provide the motion vectors to the encoder to avoid duplication of effort. For example, the content analyzer and features generator (CAFG) 102 may use either a current original frame and a past original frame or a current original frame and a past reconstructed frame for motion estimation. The former solution reduces dependencies allowing faster processing and when coding bit-rates are high to provide near identical results to the latter solution, which uses past reconstructed frame for motion estimation. The latter solution is better for higher compression efficiency, but adds dependencies. For either of the two solutions, it may be possible to perform motion estimation only once in content analyzer and features generator (CAFG) 102 for feature calculation, while also sharing motion vectors with Video Encoder 108. In such a case, performing motion estimation on a past original frame may be slight more advantageous.

The content analyzer and features generator (CAFG) 102 may calculates spatial features, motion vectors, and motion activity features for different CU/block sizes supported by HEVC, while the partitions and mode subset generator (PMSG) 104 may use these features and additional information to calculate mode subsets and partition maps. Details of content analyzer and features generator (CAFG) 102 and partitions and mode subset generator (PMSG) 104 are described in greater detail below. The output of content analyzer based partitions and mode subset generator (CAPM) system 101 includes motion vectors (mv), mode subsets (ms), and partition maps (pm), and are input to the video encoder 108 (e.g., AVC/HEVC/AV1 Frame Encoder) which may be a stripped down version of the normal AVC/HEVC/AV1 Encoder in some examples. The video encoder 108 (e.g., AVC/HEVC/AV1 Frame Encoder) may also receive reordered frames from Picture Reorderer 806, QP and refs from Encode Controller 802, and can both send reconstructed frames to and receive reconstructed past frames from the Ref List 808. The video encoder 108 (e.g., AVC/HEVC/AV1 Frame Encoder) may output a compressed bitstream that is fully compliant to the respective standard.

In some examples, the limited number of partition maps may be selected to be two partition maps and the limited number of mode subsets may be selected to be two modes per partition. For example, the limited number of partition maps include a primary partitioning map and an optional alternate partitioning map. In such an example, both the primary partitioning map and the alternate partitioning map may be generated by recursive cascading of split decisions with logical control.

Partitions and mode subset generator (PMSG) 104 may generate the limited number of partition maps based at least in part on the limited number of mode subsets.

The spatial features, described above, may include one or more of spatial-detail metrics and relationships, where the spatial feature values may be based on the following spatial-detail metrics and relationships: a spatial complexity per-pixel detail metric (SCpp) based at least in part on spatial gradient of a square root of average row difference square and average column difference squares over a given block of pixels, and a spatial complexity variation metric (SCvar) based at least in part on a difference between a minimum and a maximum spatial complexity per-pixel in a quad split.

Similarly, the temporal features, described above, may include one or more of temporal-variation metrics and relationships, where the temporal features may be based on the following temporal-variation metrics and relationships: a motion vector differentials metric (mvd), a temporal complexity per-pixel metric (SADpp) based at least in part on a motion compensated sum of absolute difference per-pixel, a temporal complexity variation metric (SADvar) based at least in part on a ratio between a minimum and a maximum sum of absolute difference-per-pixel in a quad split, and a temporal complexity reduction metric (SADred) based at least in part on a ratio between the split and non-split sum of absolute difference-per-pixel in a quad split.

In some examples, partitions and mode subset generator (PMSG) 104 may perform determinations of the limited number of mode subsets based at least in part on one or more of the following intelligent encoding functions (IEF): a force intra mode function, a try intra mode function, and a disable skip mode function. For example, the force intra mode function may be based at least in part on a threshold determination associated with the spatial complexity per-pixel detail metric (SCpp), the temporal complexity per-pixel metric (SADpp), and the motion vector differentials metric (mvd). Likewise, the try intra mode function may be based at least in part on a threshold determination associated with the spatial complexity per-pixel detail metric (SCpp), the temporal complexity per-pixel metric (SADpp), and the motion vector differentials metric (mvd). Similarly, the disable skip mode function may be based at least in part on a threshold determination associated with the temporal complexity per-pixel metric (SADpp), and motion vector differentials metric (mvd).

In some examples, partitions and mode subset generator (PMSG) 104 may perform determinations of the limited number of partition maps based at least in part on one or more of the following intelligent encoding functions (IEF): a not split partition map-type function and a force split partition map-type function. For example, the not split partition map-type function may be based at least in part on a threshold determination associated with the spatial complexity per-pixel detail metric (SCpp), the temporal complexity per-pixel metric (SADpp), the temporal complexity variation metric (SADvar), the temporal complexity reduction metric (SADred). Similarly, the force split partition map-type function may be based at least in part on a threshold determination associated with the spatial complexity per-pixel detail metric (SCpp), the temporal complexity per-pixel metric (SADpp), the temporal complexity variation metric (SADvar), and the temporal complexity reduction metric (SADred).

As noted above, partitions and mode subset generator (PMSG) 104 may perform determinations of the limited number of mode subsets based at least in part on one or more of the following intelligent encoding functions (IEF): a force intra mode function, a try intra mode function, and a disable skip mode function. In such an example, partitions and mode subset generator (PMSG) 104 may perform determinations of the limited number of partition maps based at least in part on one or more of the following intelligent encoding functions (IEF): a not split partition map-type function and a force split partition map-type function. The force intra mode function, the try intra mode function, the disable skip mode function, the not split partition map-type function, the force split partition map-type function are based at least in part on generated parameter values. Such generated parameter values may depend at least in part on one or more of the following: a coding unit size, a frame level, and a representative quantizer. For example, the frame level may indicate one or more of the following: a P-frame, a GBP-frame, a level one B-frame, a level two B-frame, and a level three B-frame. Similarly, the representative quantizer may include a true quantization parameter that has been adjusted in value based at least in part on a frame type of the current coding unit of the current frame. Likewise, the coding unit size-type parameter value may indicate one or more of the following: a sixty-four by sixty-four size coding unit, a thirty-two by thirty-two size coding unit, a sixteen by sixteen size coding unit, and an eight by eight size coding unit.

In operation, content analyzer and features generator (CAFG) 102 preanalyzer may perform analysis of content to compute spatial and temporal features of the content and some additional metrics at multiple block sizes. A number of basic measures are computed first. For instance, SAD, MV, Rs, Cs are the basic measures calculates in the pre-Analyzer. All metrics are calculated frame based on input video. SAD & MV is based on Hierarchical GPU based ME (VME) on Multiple References. Rs/Cs is computed on input video. Spatial and Temporal feature are then calculated next.

A list of all the measures and features as well as block sizes is as follows.

Basic Spatial Measures may include Rs, Cs, and RsCs for 8×8, 16×16, 32×32, and 64×64 block sizes. Rs, Cs, and RsCs are described in greater detail below.

Spatial Features may include: Spatial Complexity (SCpp) for 8×8, 16×16, 32×32, and 64×64 block sizes; and Spatial Complexity Variation (SCvar) for 16×16, 32×32, and 64×64 block sizes.

Basic Temporal Measures may include: Motion Vectors for 8×8, 16×16, 32×32, and 64×64 block sizes; and Temporal Complexity (SAD) for 8×8, 16×16, 32×32, and 64×64 block sizes.

Temporal Features may include: Motion Vector Differentials (mvd) for 8×8, 16×16, 32×32, and 64×64 block sizes; Temporal Complexity Variation (SADvar) for 16×16, 32×32, and 64×64 block sizes; Temporal Complexity per pixel (SADpp) for 8×8, 16×16, 32×32, and 64×64 block sizes; and Temporal Complexity Reduction (SADreduc) for 16×16, 32×32, and 64×64 block sizes.

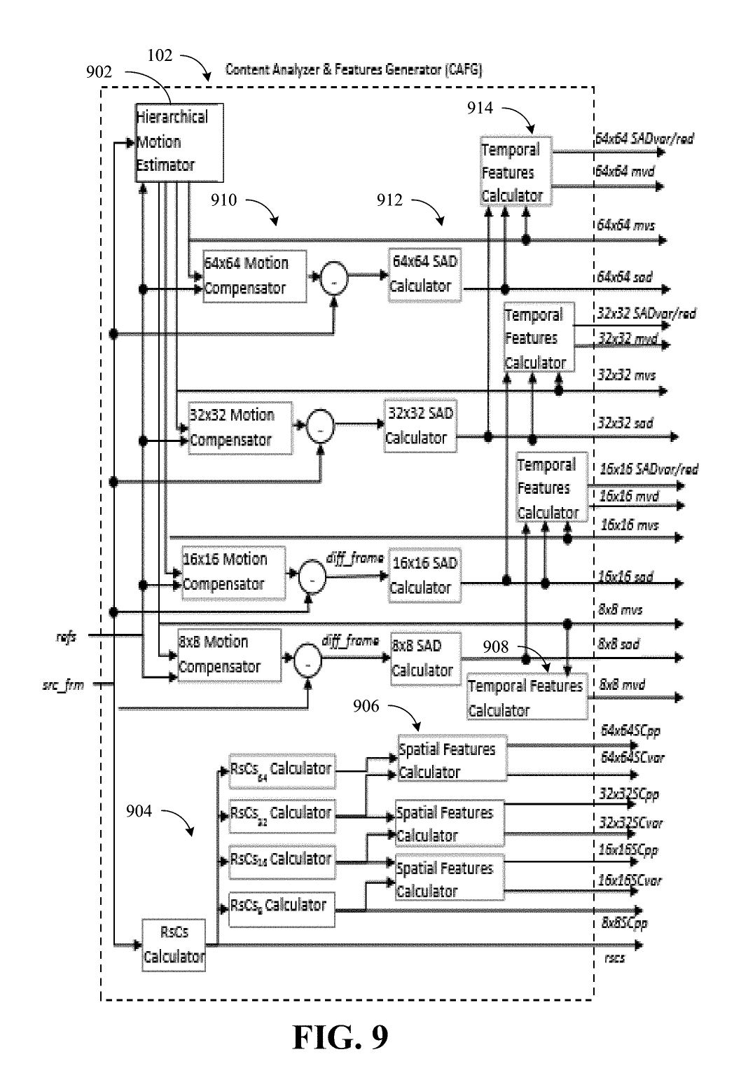

FIG. 9 shows a detailed block diagram of content analyzer and features generator (CAFG) 102, arranged in accordance with at least some implementations of the present disclosure. In various implementations, content analyzer and features generator (CAFG) 102 may perform calculation of basic spatial and temporal measures as well as all spatial and temporal features. Content analyzer and features generator (CAFG) 102 may include a hierarchical motion estimator 902 (e.g., that may be performed in a GPU), associated motion compensators 910 (of various block sizes 8×8, 16×16, 32×32, and 64×64), SAD calculators 912, 4×4 Rs, Cs calculators 904 (from which all other block size Rs, Cs is calculated), spatial features calculator 906, and temporal features calculator 908 for various block sizes as shown.

As discussed above, some aforementioned measures and features may now be formally defined with equations that may be used to calculate the same.

Spatial Complexity: Spatial complexity (SC): Spatial complexity is based on the metric RsCs. RsCs is defined as the square root of average row difference square and average column difference squares over a given block of pixels.

Rs=Square root of average previous row pixel difference squares, for a 4×4 block:

$$Rs = \sqrt{\frac{{\sum }_{i = 0}^{4} {\sum }_{j = 0}^{4} ( {P [ i ] [ [ j ] - P [ i - 1 ] [ j ] )}^{2}}{16}}$$

Cs=Square root of average previous column pixel difference squares, for a 4×4 block.

$$Cs = \sqrt{\frac{{\sum }_{i = 0}^{4} {\sum }_{j = 0}^{4} ( {P [ i ] [ [ j ] - P [ i - 1 ] [ j ] )}^{2}}{16}}$$

$$RsCs = \sqrt{{Rs}^{2} + {Cs}^{2}}$$

P is the picture pixels. Rs & Cs are always defined for 4×4 blocks. Rs², Cs² is simply the square of Rs, Cs.

SCpp_{N} is the spatial complexity for block sizes (N×N) is defined as

$${SCpp}_{N} = \frac{( {\sum }_{k = 0}^{N / 4} {\sum }_{l = 0}^{N / 4} {Rs}^{2} [ k ] [ l ] ) + ( {\sum }_{k = 0}^{N / 4} {\sum }_{l = 0}^{N / 4} {Cs}^{2} [ k ] [ l ] )}{{( \frac{N}{4} )}^{2}}$$

Temporal Complexity:

The measure used for temporal complexity is the Motion compensated SAD-per-pixel (SADpp). For SAD of N×N block SADpp is:

$$SAD = {\sum }_{i = 0}^{N} {\sum }_{j = 0}^{N} \vert S ( i , j ) - P ( i , j ) \vert$$

$${SADpp}_{N} = \frac{SAD}{{N}^{2}}$$

Where S is Source, P is Prediction and N is the block size.

In case of multiple references the bestSAD for given number of reference frame is used.

bestSAD=min(SAD[Ref])

Spatial-Temporal Complexity: SADpp gives the residual error measure of a region but cannot describe the complexity/predictability of video. Spatial-temporal complexity is a classification of the temporal complexity of a region dependent on its spatial complexity. It is discriminant curve classifier given by:

SADt=αSCpp^{β}

STC=1 if SAD>SADt

STC=0 if SAD<SADt

Spatial Complexity Variation (SCvar):

Is the difference between the minimum and maximum SC in a quad split.

SCvar=MaxSCQpp−MinSCQpp

Temporal Complexity Reduction (SADred): Is the ratio between the split and non-split SADpp in a quad split.

SADred=SADpp/SADQpp

Where SADpp is based on bestSAD for given block size, and where SADQpp is based on sum of bestSADs for Quad split blocks.

Temporal Complexity Variation (SADvar):

Is the ratio between the minimum and maximum SADpp in a quad split.

SADVar=minSADQ/maxSADQ

Where minSADQ is the minimum SAD of Quad Split blocks, and where maxSADQ is the maximum SAD of Quad Split blocks

Motion Vector Differential (mvd):

Is the MV differential using HEVC motion vector prediction scheme. Spatial prediction is done w.r.t. best reference frame while temporal prediction is w.r.t. collocated frame. The motion vectors are represented in quarter pixel units.

mvd=ABS(mv·x−pred·x)+ABS(mv·y−pred·y)

In operation, content analyzer and features generator (CAFG) 102 may include calculations of variety of spatial measures and features, as well as many temporal measures and features. While this may look like performing lots of computations, in reality calculation of these intelligent measures and features allows saving overall computations making the encoder faster without incurring additional quality loss. This is possible as content analyzer based partitions and mode subset generator (CAPM) system 101 (see FIG. 9) allows a tradeoff of some complexity added in terms of measures and features that are calculated with lots of Rate-Distortion complexity that can be saved. To understand this tradeoff better, some understanding of how the computed features are used by another major component of content analyzer based partitions and mode subset generator (CAPM) system 101, the partitions and mode subset generator (PMSG) 104 (see FIG. 8) which is discussed next.

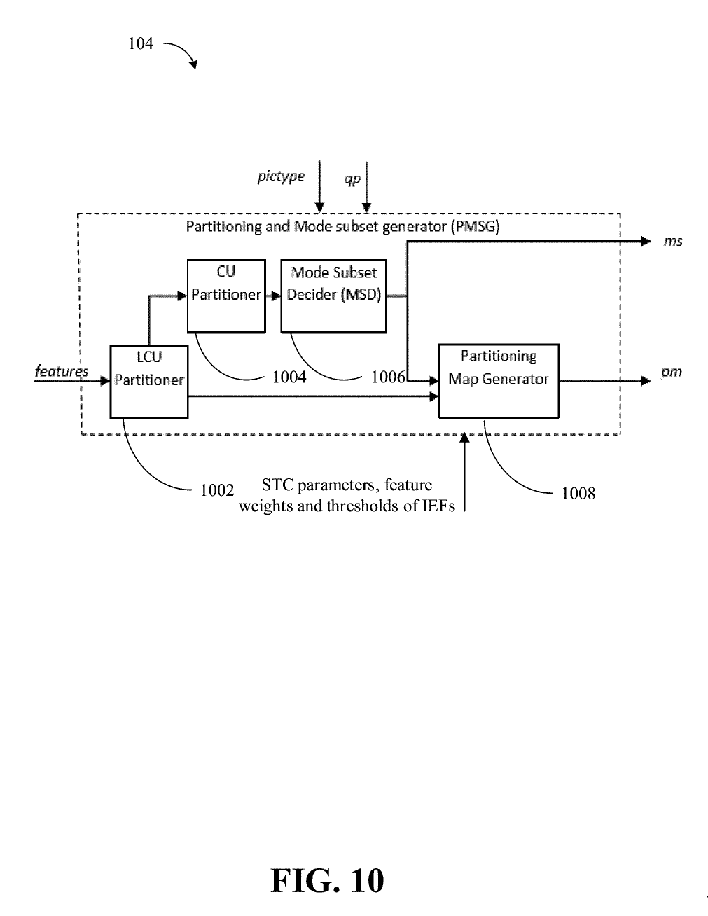

FIG. 10 shows a detailed block diagram of partitions and mode subset generator (PMSG) 104, arranged in accordance with at least some implementations of the present disclosure. In various implementations, partitions and mode subset generator (PMSG) 104 may use features content analyzer and features generator (CAFG) 102, pictype, and QP information to compute mode subsets (ms) and partitioning maps (pm). As illustrated, partitions and mode subset generator (PMSG) 104 may include a LCU partitioner unit 1002, a CU partitioner unit 1004, a Mode Subset Decider unit 1006 (MSD), and a Partitioning Map Generator unit 1008.

In operation, features may be input to LCU partitioner 1002 that partitions an LCU and provides at one input partitioning information to Partitioning Map Generator 1008. Simultaneously, the output of LCU partitioner 1002 is also provided to CU partitioner 1004 for further partitioning. The output of CU partitioner 1004 is then fed to Mode Subset Decider 1006, which decides and outputs mode subsets (ms) and at the same time also provides mode subsets as a second input to Partitioning Map Generator 1008. Further, the control parameters of: spatial-temporal complexity (STC) parameters, feature weights, and thresholds of intelligent encoder functions (IEFs), may be applied to control the Mode Subset Decider unit 1006 (MSD) as well as the Partitioning Map Generator unit 1008.

FIG. 11 shows a detailed block diagram of Mode Subset Decider unit 1006 (MSD), arranged in accordance with at least some implementations of the present disclosure. In various implementations, Mode Subset Decider unit 1006 (MSD) may use the following three selector IEFs: a Force_Intra IEF 1104, a Try_Intra IEF 1102, and a Disable_Skip IEF 1106.

For example, a typical single CU split encoding decision may include testing both Split-cases and Non-split cases. Here there are three split decision subsets at a CU level: Split_None, Split_Try, and Split_Must. Mode Subset Logic 1108 (which may include a split subset decider (SSD), not illustrated here) may use the following two selector IEFs: ‘Not_Split’ and ‘Force_Split’ to decide a split encoding decision subset for each CU. In addition to Qp, PicLvl, and CUsz conditions, the mode subset is also a training condition for split IEFs. Thus different split IEFs may be used, one for Inter only CUs, and one for Intra/Inter mixed mode CUs.

In operation, Mode Subset Decider unit 1006 takes as input CU based Features, pictype, and QP, and outputs CU based mode subsets (ms). CU Features are simultaneously input to the three IEFs used by Mode Subset Decider unit 1006, e.g., Force Intra IEF 1104, Try Intra IEF 1102, and Disable Skip IEF 1106, that output corresponding binary signals ﬁ, ti, and ds. Next, the three binary signals ﬁ, ti, and ds are combined by Mode Subset Logic 1108. As shown in Table 10, Mode Subset Logic 1108 generates a mode subset decision per CU that can be either Inter_Skip, Inter_Only, Inter_Intra, or Intra_Only as shown. Further, the control parameters of: spatial-temporal complexity (STC) parameters, feature weights, and thresholds of intelligent encoder functions (IEFs), may be applied to control the operations of Force Intra IEF 1104, Try Intra IEF 1102, and Disable Skip IEF 1106.

TABLE 10
Mode Subset Logic

| | | | Mode Subset |
|---|---|---|---|
| Ti | Fi | Ds | decision |
| 0 | X | 0 | Inter_Skip |
| 0 | X | 1 | Inter_Only |
| 1 | 0 | X | Inter_Intra |
| 1 | 1 | X | Intra_Only |

Partitioning Map Generator (PMG)

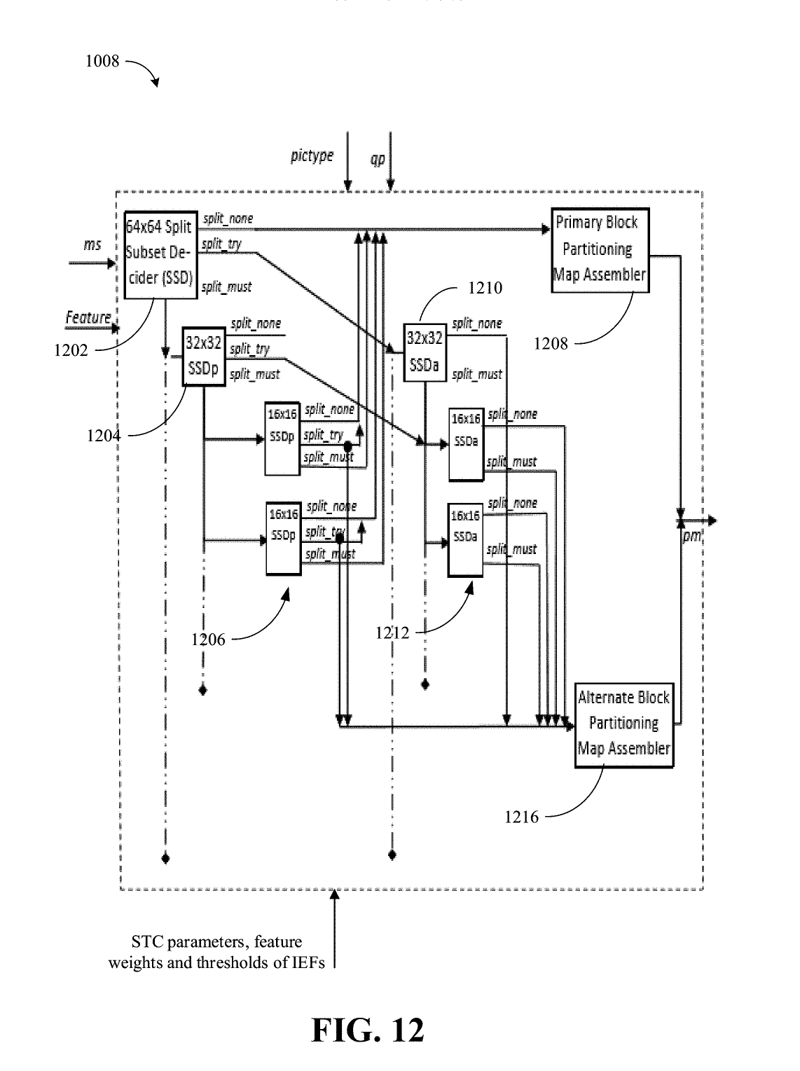

FIG. 12 shows a detailed block diagram of Partitioning Map Generator 1008 (PMG), arranged in accordance with at least some implementations of the present disclosure. In various implementations, Partitioning Map Generator 1008 (PMG) may take as input Features, ms, pictype and QP, and outputs partition maps (pm). Features and ms are analyzed through recursive stages of Split Subset Deciders (SSDs) for partitioning of LCU's (typically 64×64) into recursive splitting layers (e.g., 32×32, and 16×16). These Split Subset Deciders (SSDs) are an important component for partitioning and are described in the next section in greater detail. Further, as discussed earlier, two types of partitions are generated, a primary block partitioning map and a secondary block partitioning map, respectively known as primary block partitions, and secondary block partitions.

In the illustrated example, a 64×64 SSD 1202 may decide if a specific LCU can be either split_none, in which case primary block partition has been achieved for the LCU, or it can be split_try. If a split_try is determined, operations may proceed to 32×32 SSDa 1210 for secondary examination for splitting for alternate block partitioning. Next, for each 32×32 of this LCU in 32×32 SSDp 1204, there are again two possibilities split_none, in which case partitioning terminates adding the 32×32 CU to primary partitioning map, or split_try, in which case it goes for secondary examination for splitting for alternate block partitioning to 16×16 SSDa 1212. At the lowest level of recursive partitioning, 16×16 SDP 1206 are employed in which there are three possibilities: split_none, split_try or split_must. However, for primary partitioning, both split_none and split_try are terminating selections, whereas split must is also terminating as it represents a forced split of CU to 8×8. The split_none or split_must outputs of 64×64 SSD, 32×32 SSDp's, and 16×16 SSDp's result in the primary block partitioning map assembler 1208.

For alternate partitioning, there is only a single choice at 32×32 SSDa 1210, e.g., split_none, while the choices at 16×16 SSDa 1212 are split_none, and split_must, which are both terminating choices. The split_none or split_must outputs of 32×32 SSDas 1210, and 16×16 SSDas 1212 result in the alternate block partitioning map assembler 1216.

In operation, partitioning maps are generated by recursively cascading Split Subset Deciders (SSDs) with logical control such that there is a guarantee of single alternate partition. Split Subset Deciders (SSDs) may include primary partitioning rules (e.g., as embodied by the SSDps), including: Split_None, where the subset stops the recursion and a final partition is found; Split_Must, which forces the CU to split; and Split_Try, where the CU is marked as final partition in Primary Partition. Split Subset Deciders (SSDs) may include secondary partitioning rules (e.g., as embodied by the SSDas), including: secondary partition starts from Split_Try CUs of Primary partition; Split_None, where the subset stops the recursion and a final partition is found; Split_Must, which forces the CU to split; and Split_Try, where a subset in secondary partition stops the recursion and a final partition is found. Further, the control parameters of: spatial-temporal complexity (STC) parameters, feature weights, and thresholds of intelligent encoder functions (IEFs), may be applied to control the operations of all primary Split Subset Deciders (SSDp) and all alternate Split Subset Deciders (SSDa) in this figure.

Split Subset Decider (SSD)

FIG. 13 shows a detailed block diagram of a split subset decider 1300 (SSD), arranged in accordance with at least some implementations of the present disclosure. In various implementations, split subset decider 1300 (SSD) may determine, based on CU features, whether a CU should be split, tried to be split, or must be split. The decision may be determined from combining outcome of the two Split related IEF's.

In the illustrated example, split subset decider 1300 (SSD) takes as input CU Features, ms, pictype, and QP, and outputs CU split subsets (ss). CU Features are simultaneously input to Not Split IEF 1302 as well as Force Split IEF 1304, which correspondingly result in ns and fs binary signals respectively. The two signals are input to Split Subset Logic unit 1306, which combines the binary signals to generate one of the three possible split decisions, e.g., Split_None, Split_Try, and Split_Must. Further, the control parameters of: spatial-temporal complexity (STC) parameters, feature weights, and thresholds of intelligent encoder functions (IEFs), may be applied to control the operations of Not Split IEF 1302 and Force Split IEF 1304 in this figure.

TABLE 11
Split Subset logic

| Ns | Fs | Split Subset |
|---|---|---|
| 1 | X | Split_None |
| 0 | 0 | Split_Try |
| 0 | 1 | Split_Must |

Cascading of Decisions

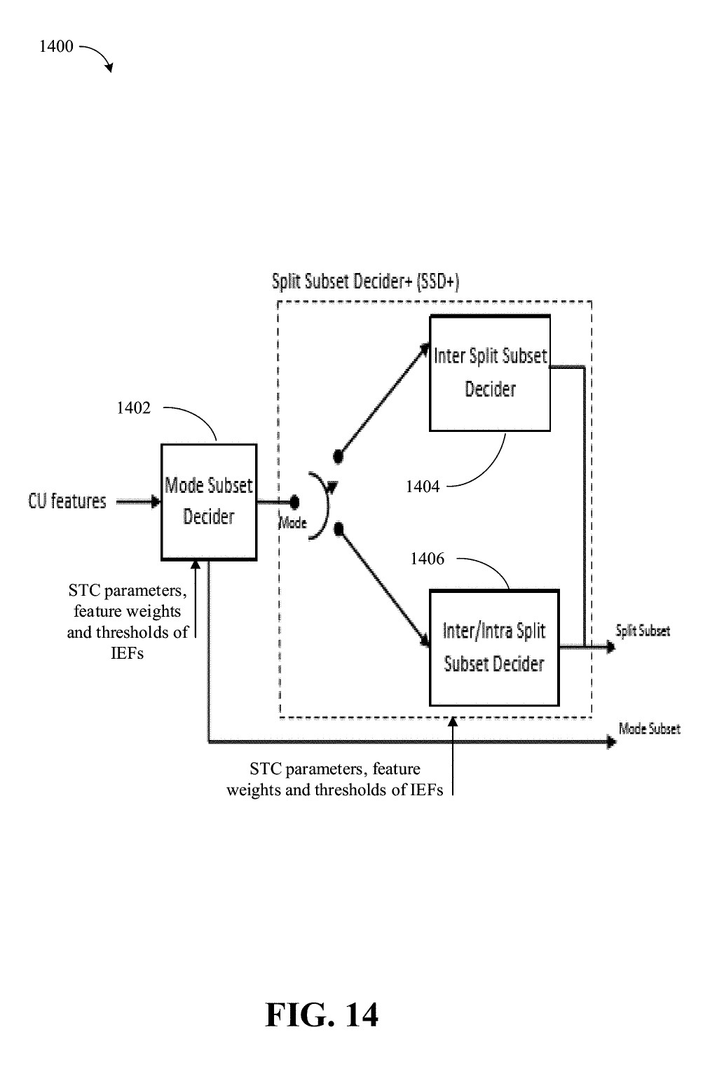

FIG. 14 shows a detailed block diagram of an alternative split subset decider 1400. (SSD), arranged in accordance with at least some implementations of the present disclosure. In various implementations, alternative split subset decider 1400 (SSD) may include a Mode Subset Decider 1402. Mode Subset Decider 1402 may compute a region (CU) mode first. Based on the mode subset decision, appropriate features can be used for split decision IEFs. Inter regions may use Inter features and regions where intra is possible (TI, FI) may use both Inter and Intra features. The scheme can be extended to use different parameter set for Split IEFs based on mode subset.

In the illustrated example, alternative split subset decider 1400 (SSD) may use higher dependency on mode subsets than split subset decider 1300 (SSD) of FIG. 13. Alternative split subset decider 1400 (SSD) is referred to as Split Subset Decider+ (SSD+) and may include two split subset deciders, the first referred to as Inter Split Subset Decider 1404, which only inter features to make splitting decisions, and the second referred to as Inter/Intra Split Subset Decider 1406, which uses all (e.g., both inter and intra features) and outputs split subsets decision. Further, the control parameters of: spatial-temporal complexity (STC) parameters, feature weights, and thresholds of intelligent encoder functions (IEFs), may be applied to control the operations of Mode Subset Decider 1402, Inter Split Subset Decider 1404, and Inter/Intra Split Subset Decider 1406 in this figure.

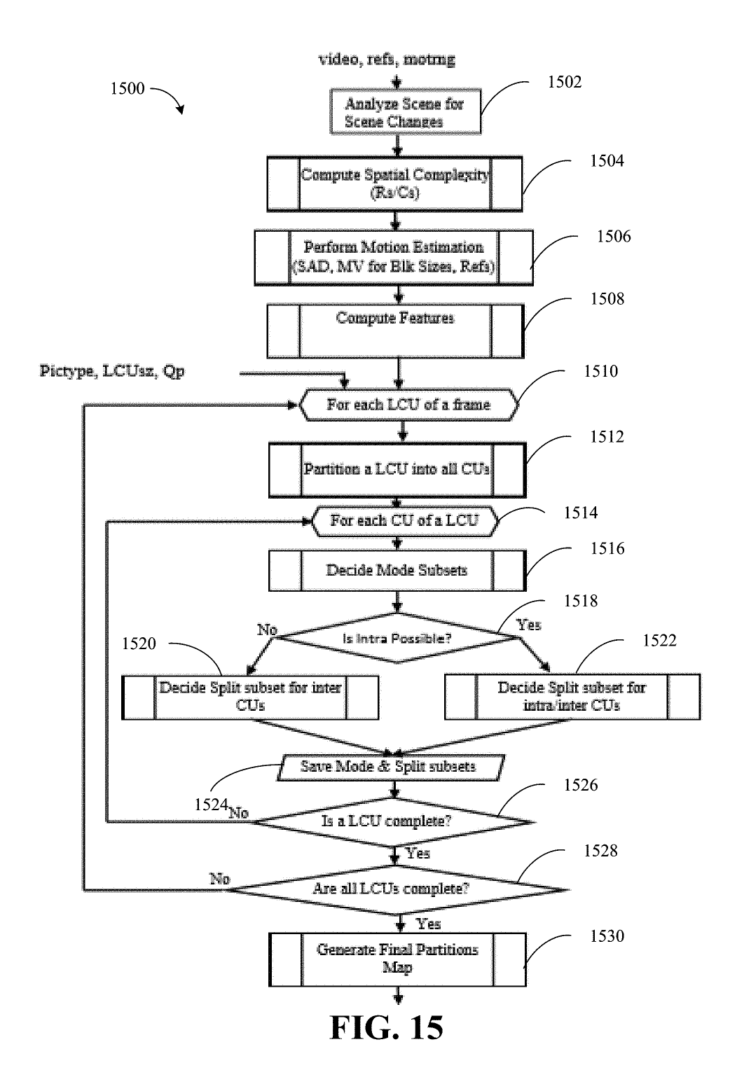

FIG. 15 shows a process 1500 of producing a limited number of partition maps and a limited number of mode subsets. The process 1500 may generally be implemented via one or more of the components of the partition and mode simplification system 100 (FIG. 1 and/or FIG. 8), already discussed.

With continuing reference to FIGS. 8-14, video frames, along with reference information and motion range information, etc., may be input to operation 1502. At operation 1502 (e.g., “Analyze Scene for Scene Change”), a video sequence to be encoded may be analyzed for scene change occurrences. For example, video frames, along with reference information and motion range information are input to determines if a scene change has taken place between the current and a previous reference frame. In the unusual instance that there is a scene change, for the current frame only spatial complexity, and spatial features are calculated and only spatial processing such as that for Intra LCU's is performed such as deciding splitting subset for intra CUs. In the more normal case of no scene change, both the spatial and temporal features are computed.

At operation 1504 (e.g., “Compute Spatial Complexity (Rs/Cs)”), spatial complexity may be computed. For example, content analyzer and features generator (CAFG) 102 may include a 4×4 Rs, Cs calculators 904 (from which all other block size Rs, Cs may be calculated).

At operation 1506 (e.g., “Perform Motion Estimation (SAD, MV for Blk Sizes, Refs”), motion estimation may be performed. For example, content analyzer and features generator (CAFG) 102 may include a hierarchical motion estimator 902 (e.g., that may be performed in a GPU) to perform such motion estimation. Additionally, content analyzer and features generator (CAFG) 102 may include a SAD calculators 912 to compute SAD values of various block sizes (e.g., block sizes 8×8, 16×16, 32×32, and 64×64 block sizes).

At operation 1508 (e.g., “Compute Features”), features may be computed. As discussed herein, content analyzer and features generator (CAFG) 102 may compute IEF features based at least in part on the output of operations 1504 and 1506 to deliver features to partitioning and mode subsets generator (PMSG) 104.

At operation 1510 (e.g., “For each LCU of a frame”), operations may continue in a loop for each largest coding unit of a frame.

Codec parameters, such as picture type, largest coding unit block size QP, etc., may be input to operation 1510. A particular implementation of a Codec or Encoder of a standard (such as HEVC) may use either a few (say 5 parameters) or many more (say even up to 50 or more parameters)—it depends on the video codec standard (e.g., MPEG-2 vs. AVC vs. HEVC), the intended user (e.g., an average users vs. experts), codec controls (e.g., easy to configure or hardwired), coding quality/speed tradeoffs (e.g., high, medium, or fast) and others. For example, there are many possible input parameters including but not limited to NumRef, GOP size, GOP Structure, LCU size, Max/Min CU Sizes, Intra Prediction directions (e.g., 9, 36, or others), Motion Range, Motion Estimation Accuracy, Intra frame frequency, Intra frame type (Ultra-High Throughput Intra (IDR) frames, Clean Random Access (CRA) frames, or other), Max/Min Transform size, rate/quality control parameters.

Additionally, Input Quality/Rate Control parameters can several parameters, for instance, Input Quality/Rate Control parameters might include Intra Quantizer (Qpi), P-frame Quantizer, (Qpp), B-frame quantizer (Qpb), reference quantizer (Qpr), Bitrate Control (BRC) method (e.g., Constant Bit Rate (CBR), Variable Bit Rate (VBR), or Average Variable Bit Rate (AVBR), Buffer Size, Max Frame Size, Hypothetical Reference Decoder (HRD) compliance, the like, and/or combinations thereof.

At operation 1512 (e.g., “Partition a LCU into all CUs”), all possible coding unit partitions may be coded. For example, partitioning and mode subsets generator (PMSG) 104 may include LCU partitioner 1002 and CU partitioner 1004. Features may be input to LCU partitioner 1002 that partitions an LCU and provides input partitioning information to Partitioning Map Generator 1008. Simultaneously, the output of LCU partitioner 1002 is also provided to CU partitioner 1004 for further partitioning.

At operation 1514 (e.g., “For each CU of a LCU”), operations may continue in a loop for each coding unit of a largest coding unit. For example, operations 1516-1524 may be iteratively repeated for each bock.

At operation 1516 (e.g., “Decide Mode Subsets”), mode subsets (ms) may be computed. For example, partitioning and mode subsets generator (PMSG) 104 may include Mode Subset Decider 1006. The output of CU partitioner 1004 may be fed to Mode Subset Decider 1006, which decides and outputs mode subsets (ms) and at the same time also provides mode subsets as a second input to Partitioning Map Generator 1008.

At operation 1518 (e.g., “Is Intra Possible?”), a decision may be made as to whether Intra is possible. For example, based on the mode subset decision by Mode Subset Decider 1006, appropriate features can be used for split decision IEFs. Inter regions may use Inter features and regions where intra is possible (TI, FI) may use both Inter and Intra features. The scheme can be extended to use different parameter set for Split IEFs based on mode subset.

At operation 1520 (e.g., “Decide Split subset for Inter CUs”), inter split subsets may be decided. For example, split subset decider 1400 (SSD) takes as input CU Features, ms, pictype, and QP, and outputs CU split subsets (ss). Split subset decider 1400 (SSD) may include a first split subset decider, Inter Split Subset Decider 1404, which only uses inter features to make splitting decisions

At operation 1522 (e.g., “Decide Split subset for Intra/Inter CUs”), intra/inter splits may be decided. For example, split subset decider 1400 (SSD) takes as input CU Features, ms, pictype, and QP, and outputs CU split subsets (ss). Split subset decider 1400 (SSD) may include a second split subset decider, Inter/Intra Split Subset Decider 1406, which uses all (e.g., both inter and intra features) and outputs split subsets decision.

At operation 1524 (e.g., “Save Mode & Split subsets”), the modes and split subsets from operations 1516, 1520, and 1522 may be saved for later use.

At operation 1526 (e.g., “Is a LCU complete?”), a decision may be made whether processing is complete for each coding unit of a largest coding unit.

At operation 1528 (e.g., “Are all LCUs complete?”), a decision may be made whether processing is complete for each largest coding unit of a frame.

At operation 1530 (e.g., “Generate Final Partitions Map”), final partitions may be generated. For example, Partitioning Map Generator 1008 (PMG) may take as input Features, ms, pictype and QP, and outputs final partition maps (pm). More specifically, Partitioning Map Generator 1008 (PMG) may include primary block partitioning map assembler 1208 and/or alternate block partitioning map assembler 1216. For example, the split_none or split_must outputs of 64×64 SSD, 32×32 SSDp's, and 16×16 SSDp's may result in the primary block partitioning map assembler 1208. For alternate partitioning, there may be only a single choice at 32×32 SSDa 1210, e.g., split_none, while the choices at 16×16 SSDa 1212 are split_none, and split_must, which are both terminating choices. The split_none or split_must outputs of 32×32 SSDas 1210, and 16×16 SSDas 1212 result in the alternate block partitioning map assembler 1216.

In operation, FIG. 15 shows a high level process 1500 of Content Analysis Based Partitioning and Mode Subsets (CAPM) 104. Video frames, along with reference information and motion range information are input to the Analyze Scene for Scene Change process that determines if a scene change has taken place between the current and a previous reference frame. In the unusual instance that there is a scene change, for the current frame only spatial complexity, and spatial features are calculated and only spatial processing such as that for Intra LCU's is performed such as deciding splitting subset for intra CUs. In the more normal case of no scene change, both the spatial and temporal features are computed. For instance, first the “Compute Spatial Complexity” process calculates spatial complexity measures such as row based measure Rs, column based measure Cs, and the joint measure RsCs. Next, in the Perform Motion Estimation process, motion estimation is performed using ‘refs’ distance, between the current frame and the reference frame. With respect to each reference, a motion vector is computed for each block (or CU) along with the SAD motion compensation of that block (or CU) produces. Next, Compute Features process calculates additional spatial features such as spatial complexity per pixel (SCpp) and temporal (or spatial-temporal) features such as per pixel SAD (SADpp) and best SAD of number of references (bestSAD), spatial-temporal complexity (STC), spatial-complexity variation (SCvar), temporal complexity reduction (SADred), temporal complexity variation (SADvar), and motion vector differential (mvd).

Next, using some of input parameters such as (refs), additional parameters (pictype, LCUsz, QP, and aforementioned calculated features), each LCU of current frame is processed via For each LCU of a Frame loop, to determine modes and splits subsets. To this end, first each LCU is partitioned into all possible CUs. Next, For each CU of a LCU loop starts for each CU with determining mode subsets in Decide Mode Subsets process. Based on the mode subsets selected, if intra mode is possible (such as in the case of Intra_Only, or Intra_Inter mode subsets) then Decide Split subset for Intra/Inter CUs process is called. On the other hand, if intra mode is not a possibility due to chosen mode subsets, then the Decide Split subset for Inter CUs process is called. Next, output of either the Decide Split subset for Intra/Inter CUs, or the Decide Split subset for Inter CUs process is stored for future use by the Save Mode & Split subsets process. This is followed by testing of the condition Is the LCU complete, to determine if it is complete or not, if not complete, the for each CU of a LCU loop is executed again for the next CU. On the other hand, if the LCU is complete, the condition, Are all LCUs complete is evaluated to determine if all LCUs are complete or not. If not complete, the loop For each LCU of a frame is executed for the next LC; however, if all LCUs are complete, the for loop exit having determined the necessary data, e.g., all the mode and split subsets for all CU partitioning of an LCU for all LCUs of the frame. The generated mode and split subsets data is then input to Generate Final Partitions Map process that generates the primary and secondary partitions (for each LCU) for the entire frame.

Embodiments of the method 1500 (and other methods herein) may be implemented in a system, apparatus, processor, reconfigurable device, etc., for example, such as those described herein. More particularly, hardware implementations of the method 1500 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 1500 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, embodiments or portions of the method 1500 (and other methods herein) may be implemented in applications (e.g., through an application programming interface/API) or driver software running on an OS. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

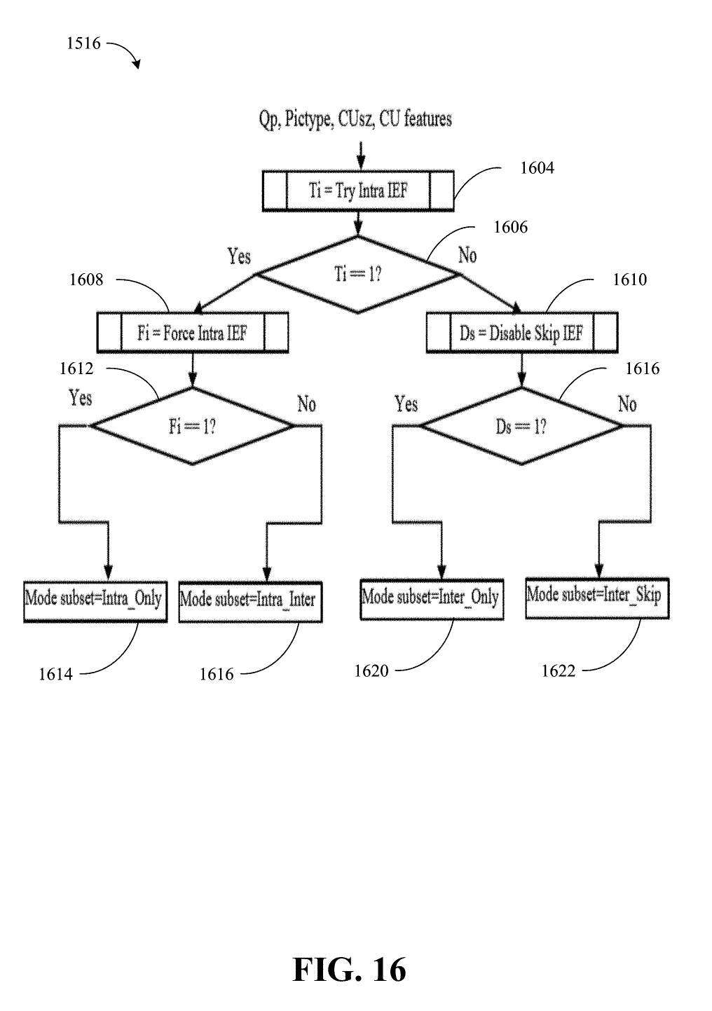

FIG. 16 shows a detailed flowchart for a mode subset decider process 11516. The process 1516 may generally be implemented via one or more of the components of the mode subset decider 1006 (FIG. 11), already discussed.

With continuing reference to FIG. 11, Qp, picture type, coding unit size, and coding unit features may be input.

At operation 1604 (e.g., “Ti=Try Intra IEF”), a Try Intra IEF 1102 is computed.

At operation 1606 (e.g., “Ti==1?”), a determination is made as to whether the binary signal (ti) output from Try Intra IEF 1102 indicates trying intra or not.

At operation 1608 (e.g., “Fi=Force Intra IEF”), a Force Intra IEF 1104 is computed when operation 1606 indicates to try intra.

At operation 1610 (e.g., “Ds=Disable Skip IEF”), a Disable Skip IEF 1106 is computed when operation 1606 indicates not to try intra.

At operation 1612 (e.g., “Fi==1?”), a determination is made as to whether the binary signal (ﬁ) output from Force Intra IEF 1104 indicates forcing intra or not.

At operation 1614 (e.g., “Mode subset=Intra_only”), the mode subset may be set to indicate intra only, when operation 1612 indicates forcing intra.

At operation 1616 (e.g., “Mode subset=Intra_Inter”), the mode subset may be set to indicate intra or inter when operation 1612 indicates not forcing intra.

At operation 1618 (e.g., “Ds==l?”), a determination is made as to whether the binary signal (ds) output from Disable Skip IEF 1106 indicates disabling skip or not.

At operation 1620 (e.g., “Mode subset=Inter_only”), the mode subset may be set to indicate inter only, when operation 1618 indicates not disabling skip.

At operation 1622 (e.g., “Mode subset=Inter_Skip”), the mode subset may be set to indicate inter skip, when operation 1618 indicates disabling skip.

In operation, FIG. 16 shows the high level process 1516 of the Decide Mode subsets process used in FIG. 15. The input to process 1516 includes a list of parameters and features including Qp, Pictype, CUsz, and CU spatial and temporal features. The process 1516 for determining the mode subsets starts with calling the Try Intra IEF function that returns a binary flag, Ti. If Ti is set to 1, the Force Intra IEF function is called next and returns another binary flag, Fi. If Fi is set to ‘1’, Intra_Only mode subset may be allocated to the current CU; on the other hand if Fi is not equal to ‘1’ then the Intra_Inter mode subset may be allocated to the current TU. Furthermore, if Ti was not set to ‘1’ than Disable Skip IEF function is called that returns a binary flag Ds. If Ds is set to ‘1’, then Inter_Only mode subset is allocated to the current CU, however, if Ds is not set to ‘1’ then Inter_Skip mode subset is allocated to the current CU.

In operation, Mode Subset Decider unit 1006 takes as input CU based Features, pictype, and QP, and outputs CU based mode subsets (ms). CU Features are simultaneously input to the three IEFs used by Mode Subset Decider unit 1006, e.g., Force Intra IEF 1104, Try Intra IEF 1102, and Disable Skip IEF 1106, that output corresponding binary signals ﬁ, ti, and ds. Next, the three binary signals ﬁ, ti, and ds are combined by Mode Subset Logic 1108.

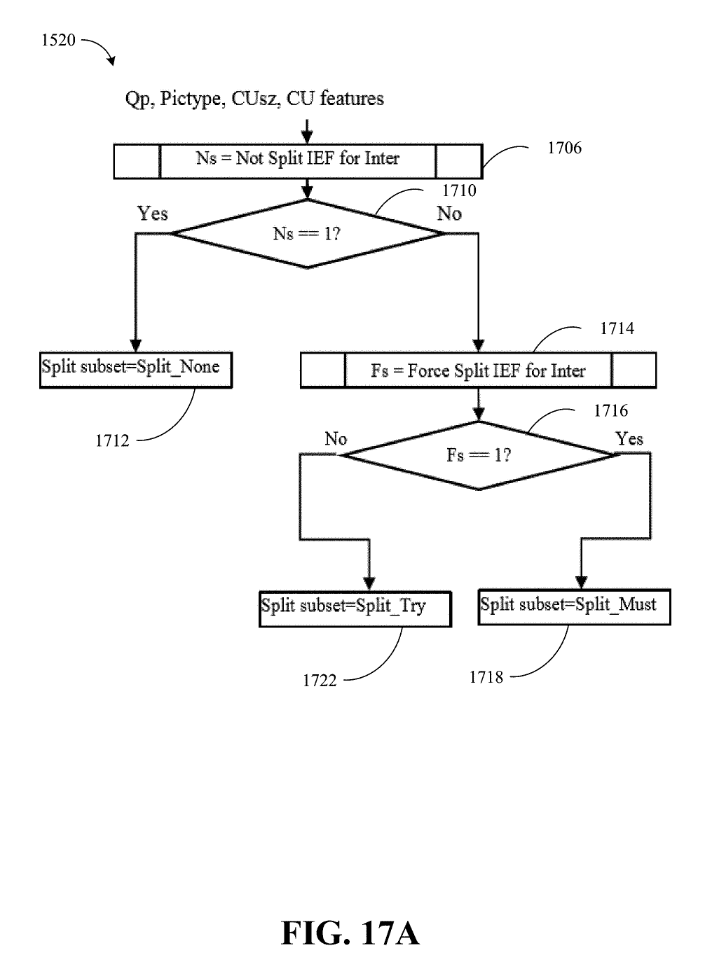

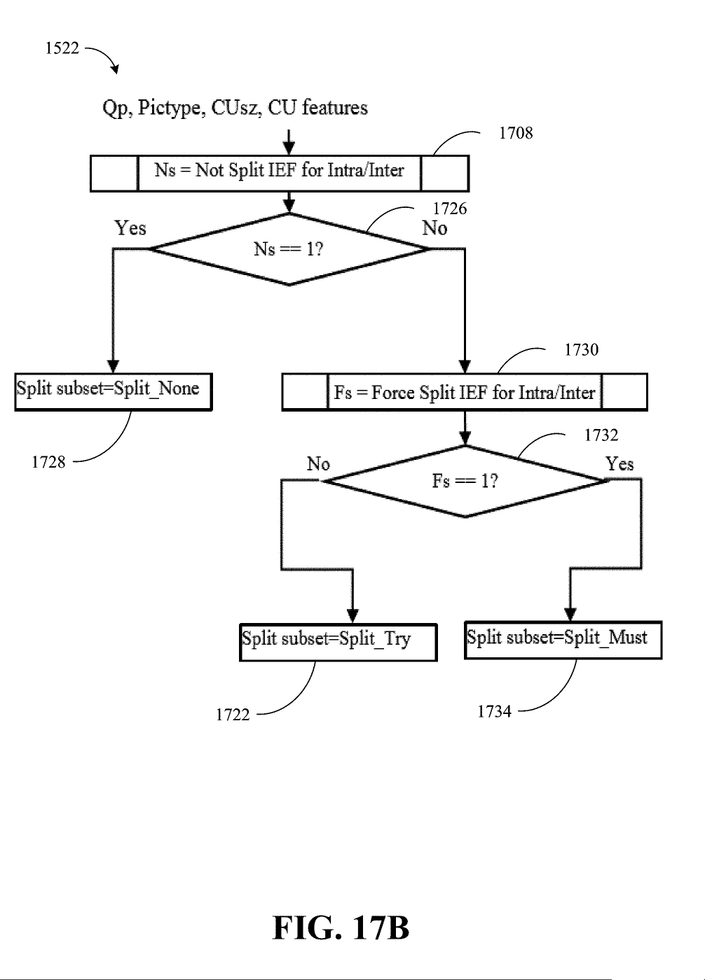

FIG. 17A shows a detailed flowchart for a split subset decider process 1520 for inter coding units.

The process 1520 may generally be implemented via one or more of the components of the split subset decider 1300 (FIG. 13) and or the split subset decider 1400 (FIG. 14), already discussed.

With continuing reference to FIG. 14, Qp, picture type, coding unit size, coding unit features, and mode subsets may be input into process 1520

At operation 1706 (e.g., “Ns=Not Split IEF for Inter”), operation 1706 may compute a Not Split IEF for Inter. For example, split subset decider 1400 (SSD) may include a subset decider, referred to as Inter Split Subset Decider 1404, which may use inter features and outputs split subsets decision.

At operation 1710 (e.g., “Ns==l?”), a determination is made as to whether the binary signal (ns) output from Not Split IEF for Intra indicates not splitting or not.

At operation 1712 (e.g., “Split subset=Split_none”), in response to operation 1710 indicating not splitting, operation 1712 may determine no splits for the subset.

At operation 1714 (e.g., “FS=Force Split IEF for Inter”), in response to operation 1710 indicating not-not splitting, operation 1714 may compute a Force Split IEF for Inter.

At operation 1716 (e.g., “Fs==1?”), a determination is made as to whether the binary signal (fs) output from Force Split IEF for Intra indicates force splitting or not.

At operation 1718 (e.g., “Split subset=Split_Must”), in response to operation 1716 indicating forced splitting, operation 1718 may determine a must split for the subset.

At operation 1722 (e.g., “Split subset=Split_Try”), in response to operation 1716 indicating forced splitting, operation 1722 may determine a try split for the subset.

In operation, FIG. 17A shows the high level flowchart of the Decide Split subsets for Inter process 1520 used in testing on potential intra CUs. The input to this process 1520 includes a list of parameters and features including Qp, Pictype, CUsz, and CU spatial and temporal features. The process of determining the split subset starts with calling the Not Split IEF for Inter function that returns a binary flag, Ns. If Ns is set to 1, split subset Split_None is allocated to the current CU. On the other hand if Ns is not set to ‘1’, than the Force Split IEF for Inter function is called and returns a binary flag Fs. Next, Fs is tested to determine if it is set to ‘1’, and if so, the split subset Split_Try is allocated to the current CU. However, if Fs is not set to ‘1’, then the split subset Split_Must is allocated to the current CU.

FIG. 17B shows a detailed flowchart for a split subset decider process 1522 for intra/inter coding units.

The process 1522 may generally be implemented via one or more of the components of the split subset decider 1300 (FIG. 13) and or the split subset decider 1400 (FIG. 14), already discussed.

With continuing reference to FIG. 14, Qp, picture type, coding unit size, coding unit features, and mode subsets may be input into process 1522.

At operation 1708 (e.g., “Ns=Not Split IEF for Intra Inter”), operation 1708 may compute a Not Split IEF for Intra_Inter. For example, split subset decider 1400 (SSD) may include a subset decider, referred to as Inter/Intra Split Subset Decider 1406, which may use all features (e.g., both inter and intra features) and outputs split subsets

At operation 1726 (e.g., “Ns==1?”), in response to operation 1708, a determination is made as to whether the binary signal (ns) output from Not Split IEF for Intra/Inter indicates not splitting or not.

At operation 1728 (e.g., “Split subset=Split_none”), in response to operation 1726 indicating not splitting, operation 1728 may determine no splits for the subset.

At operation 1730 (e.g., “FS=Force Split IEF for Intra/Inter”), in response to operation 1726 indicating not-not splitting, operation 1730 may compute a Force Split IEF for Intra/Inter.

At operation 1732 (e.g., “Fs==1?”), a determination is made as to whether the binary signal (fs) output from Force Split IEF for Intra/Inter indicates force splitting or not.

At operation 1734 (e.g., “Split subset=Split_Must”), in response to operation 1732 indicating forced splitting, operation 1734 may determine a must split for the subset.

At operation 1722 (e.g., “Split subset=Split_Try”), in response to operation 1732 indicating forced splitting, operation 1722 determine a try split for the subset.

In operation, FIG. 17B shows the high level flowchart of the Decide Split subsets for Intra/Inter process 1522 used in testing on potential intra CUs. The input to this process 1522 includes a list of parameters and features including Qp, Pictype, CUsz, and CU spatial and temporal features. The process of determining the split subset starts with calling the Not Split IEF for Intra/Inter Inter function that returns a binary flag, Ns. If Ns is set to 1, split subset Split_None is allocated to the current CU. On the other hand if Ns is not set to ‘1’, than the Force Split IEF for Intra/Inter function is called and returns a binary flag Fs. Next, Fs is tested to determine if it is set to ‘1’, and if so, the split subset Split_Try is allocated to the current CU. However, if Fs is not set to ‘1’, then the split subset Split_Must is allocated to the current CU.

Referring to both FIGS. 17A and 17B, in operation, a typical single CU split encoding decision may include testing both Split-cases and Non-split cases. Here there are three split decision subsets at a CU level: Split_None, Split_Try, and Split_Must. Split subset decider 1400 (SSD) may use the following two selector IEFs: ‘Not_Split’ and ‘Force_Split’ to decide a split encoding decision subset for each CU. In addition to Qp, PicLvl, and CUsz conditions, the mode subset is also a training condition for split IEFs. Thus different split IEFs may be used, one for Inter only CUs, and one for Intra/Inter mixed mode CUs.

IEF Effectiveness Metrics

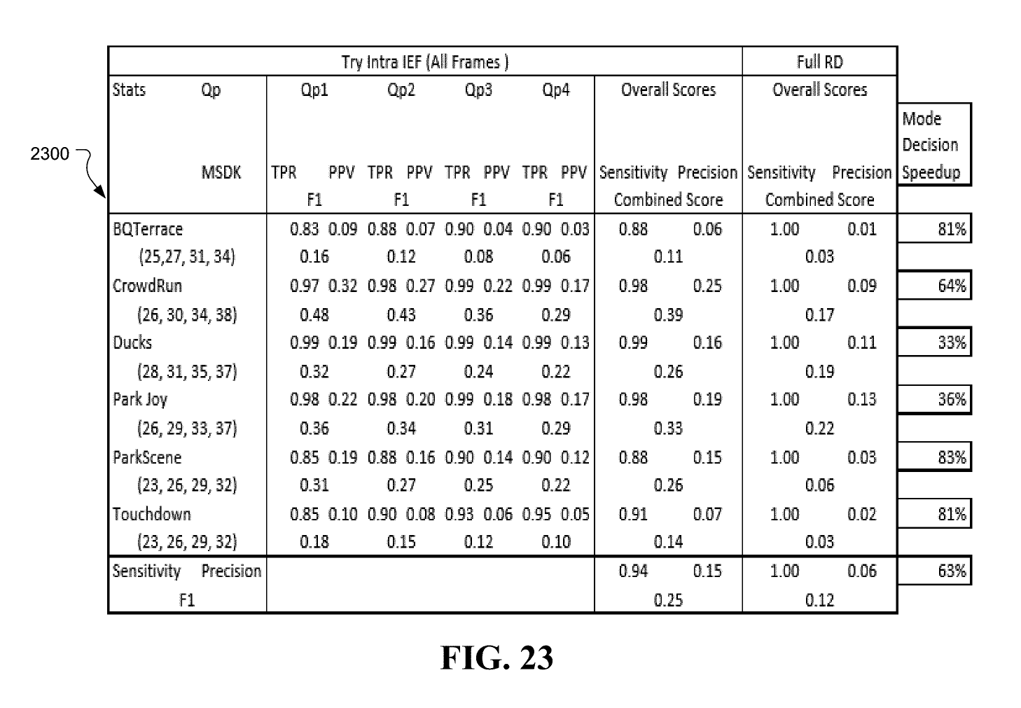

FIG. 23 is an illustrative table 2300 of an effectiveness measurement tested on several video sequences according to an embodiment. As illustrated in table 2300, IEF Effectiveness Measurements were based on the following criteria: (Sensitivity=TPR (True Positive Rate)=(True Positives)/(Positive Instances), Precision=PPV (Positive Predictive Value)=(True Positives)/(Positive Predictions), Sensitivity 1.0=No Loss in Compression Efficiency, Precision 1.0=Highest possible Speedup, F1=Combined Score=2*TPR*PPV/(TPR+PPV)).

Table 2300 shows measurements of correlation of the “Try Intra IEF” based selection with respect to actual mode selection from ideal encoding (of 6 publicly available HD1080p sequences with four different quantizer values) with the procedures disclosed herein implemented in an Intel® Media SDK (MSDK) HEVC codec. For each of four Qp's for each sequence, the TPR (true positive rate or sensitivity), and PPV (positive predictive value or precision) and Fp values were computed and used to derive Combined Sensitivity, Combined Precision, and Combined Score. For instance, the ideal sensitivity score for full RD should be a 1, the ideal precision score should be small (e.g., say around 0.01), and the ideal combined score should also be very small (say around 0.05) so the closer the system described herein is with respect to these score for a sequence, the better the speedup results will be for the sequence. Actual results of the reduced RD ‘Try Intra IEF’ approach disclosed herein is shown for each of these metrics to compare with value obtained for the case of full RD. Average values of each of these scores have also been calculated for the full RD as well as for the reduced RD operations disclosed herein (e.g., using the IEF operations described herein). The last column of table 2300 also shows actual mode decision speedup of the “Try Intra IEF” based reduced RD approach disclosed herein for each sequence. The range of improvements shown, while they may vary, are quite significant showing as much as over an 81% speedup.

Gains from IEF's in an Actual Codec

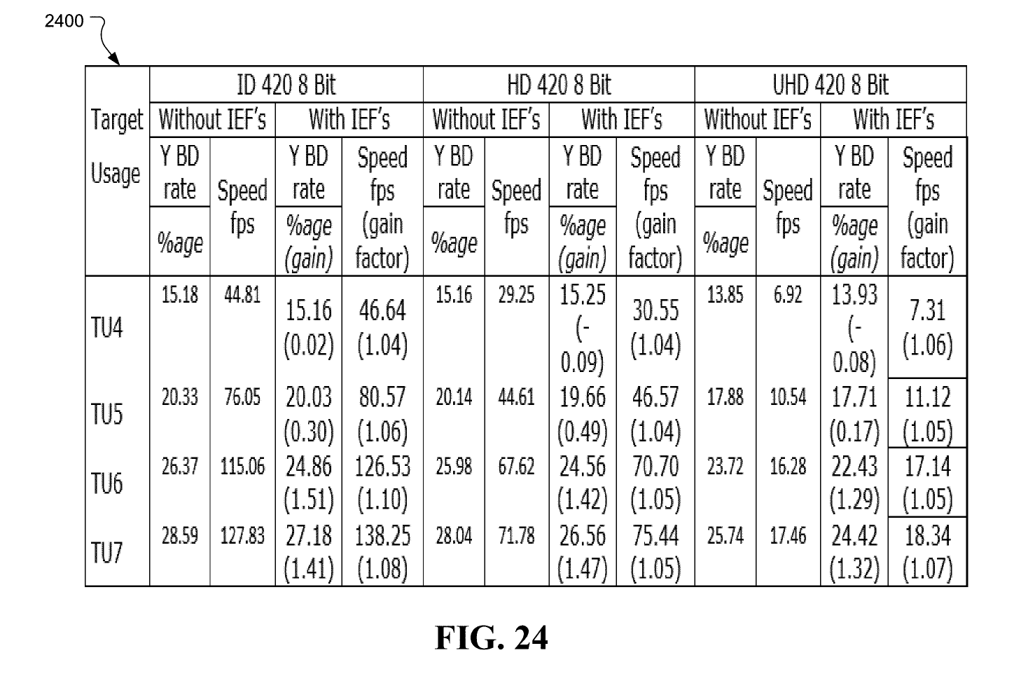

FIG. 24 is an illustrative table 2400 of experimental results of quality and speed performance according to an embodiment. As proof of concept, IEFs were ported to an HEVC GPU Accelerated (GAcc) codec to measure quality and speed performance in a real codec. From table 2300, IEF based coding can be seen to provide up to 10% improvement in performance while providing up to 1.5% improvement in compression efficiency.

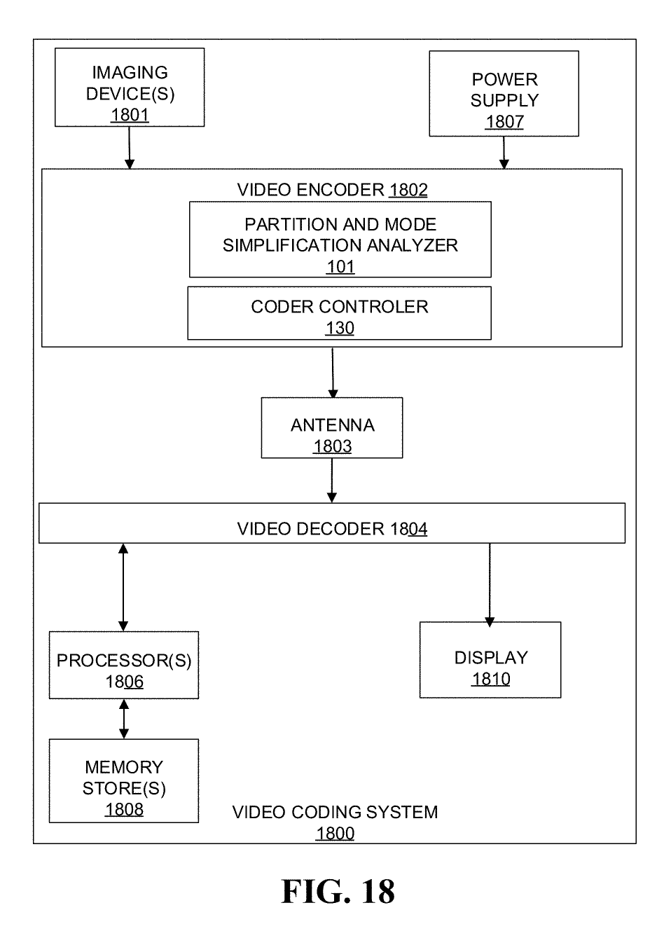

FIG. 18 is an illustrative diagram of example video coding system 1800, arranged in accordance with at least some implementations of the present disclosure. In the illustrated implementation, video coding system 1800, although illustrated with both video encoder 1802 and video decoder 1804, video coding system 1800 may include only video encoder 1802 or only video decoder 1804 in various examples. Video coding system 1800 may include imaging device(s) 1801, an antenna 1803, one or more processor(s) 1806, one or more memory store(s) 1808, a power supply 1807, and/or a display device 1810. As illustrated, imaging device(s) 1801, antenna 1803, video encoder 1802, video decoder 1804, processor(s) 1806, memory store(s) 1808, and/or display device 1810 may be capable of communication with one another.

In some examples, video coding system 1800 may include a partition and mode simplification analyzer 101 (e.g. content analyzer based partitions and mode subset generator (CAPM) system 101 of FIG. 1) and coder controller 802 (e.g., encode controller 802 of FIG. 8B) associated with video encoder 1802 and/or video decoder 1804. Further, antenna 1803 may be configured to transmit or receive an encoded bitstream of video data, for example. Processor(s) 1806 may be any type of processor and/or processing unit. For example, processor(s) 1806 may include distinct central processing units, distinct graphic processing units, integrated system-on-a-chip (SoC) architectures, the like, and/or combinations thereof. In addition, memory store(s) 1808 may be any type of memory. For example, memory store(s) 1808 may be volatile memory (e.g., Static Random Access Memory (SRAM), Dynamic Random Access Memory (DRAM), etc.) or non-volatile memory (e.g., flash memory, etc.), and so forth. In a non-limiting example, memory store(s) 1808 may be implemented by cache memory. Further, in some implementations, video coding system 1800 may include display device 1810. Display device 1810 may be configured to present video data.

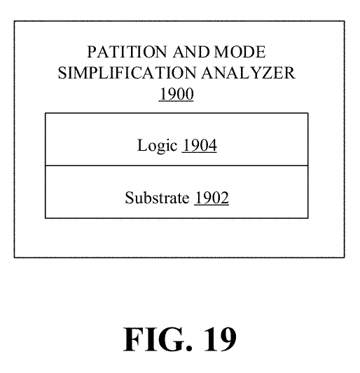

FIG. 19 shows a partition and mode simplification analyzer apparatus 1900 (e.g., semiconductor package, chip, die). The apparatus 1900 may implement one or more aspects of process 1500, 1516, 1520 or 1522 (FIG. 15-17B). The apparatus 1900 may be readily substituted for some or all of the partition and mode simplification analyzer 101 (FIG. 1), already discussed.

The illustrated apparatus 1900 includes one or more substrates 1902 (e.g., silicon, sapphire, gallium arsenide) and logic 1904 (e.g., transistor array and other integrated circuit/IC components) coupled to the substrate(s) 1902. The logic 1904 may be implemented at least partly in configurable logic or fixed-functionality logic hardware.

Moreover, the logic 1904 may configure one or more first logical cores associated with a first virtual machine of a cloud server platform, where the configuration of the one or more first logical cores is based at least in part on one or more first feature settings. The logic 1904 may also configure one or more active logical cores associated with an active virtual machine of the cloud server platform, where the configuration of the one or more active logical cores is based at least in part on one or more active feature settings, and where the active feature settings are different than the first feature settings.

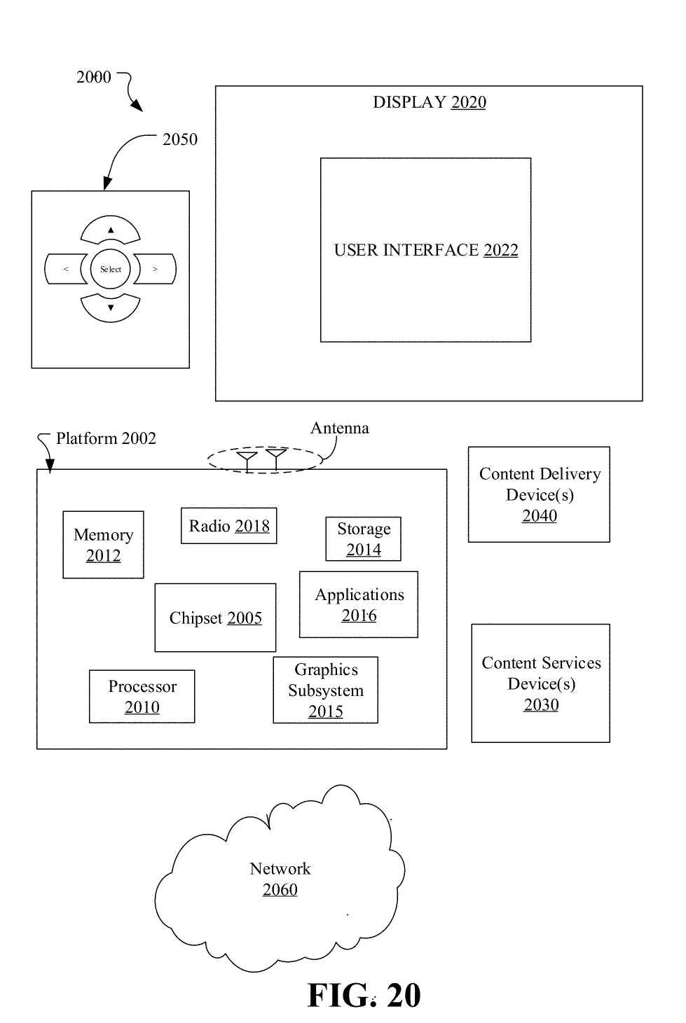

FIG. 20 illustrates an embodiment of a system 2000. In embodiments, system 2000 may include a media system although system 2000 is not limited to this context. For example, system 2000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, the system 2000 comprises a platform 2002 coupled to a display 2020 that presents visual content. The platform 2002 may receive video bitstream content from a content device such as content services device(s) 2030 or content delivery device(s) 2040 or other similar content sources. A navigation controller 2050 comprising one or more navigation features may be used to interact with, for example, platform 2002 and/or display 2020. Each of these components is described in more detail below.

In embodiments, the platform 2002 may comprise any combination of a chipset 2005, processor 2010, memory 2012, storage 2014, graphics subsystem 2015, applications 2016 and/or radio 2018 (e.g., network controller). The chipset 2005 may provide intercommunication among the processor 2010, memory 2012, storage 2014, graphics subsystem 2015, applications 2016 and/or radio 2018. For example, the chipset 2005 may include a storage adapter (not depicted) capable of providing intercommunication with the storage 2014.

The processor 2010 may be implemented as Complex Instruction Set Computer (CISC) or Reduced Instruction Set Computer (RISC) processors, ×86 instruction set compatible processors, multi-core, or any other microprocessor or central processing unit (CPU). In embodiments, the processor 2010 may comprise dual-core processor(s), dual-core mobile processor(s), and so forth.

The memory 2012 may be implemented as a volatile memory device such as, but not limited to, a Random Access Memory (RAM), Dynamic Random Access Memory (DRAM), or Static RAM (SRAM).

The storage 2014 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 2014 may comprise technology to increase the storage performance enhanced protection for valuable digital media when multiple hard drives are included, for example.

The graphics subsystem 2015 may perform processing of images such as still or video for display. The graphics subsystem 2015 may be a graphics processing unit (GPU) or a visual processing unit (VPU), for example. An analog or digital interface may be used to communicatively couple the graphics subsystem 2015 and display 2020. For example, the interface may be any of a High-Definition Multimedia Interface (HDMI), DisplayPort, wireless HDMI, and/or wireless HD compliant techniques. The graphics subsystem 2015 could be integrated into processor 2010 or chipset 2005. The graphics subsystem 2015 could be a stand-alone card communicatively coupled to the chipset 2005. In one example, the graphics subsystem 2015 includes a noise reduction subsystem as described herein.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 2018 may be a network controller including one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 2018 may operate in accordance with one or more applicable standards in any version.

In embodiments, the display 2020 may comprise any television type monitor or display. The display 2020 may comprise, for example, a computer display screen, touch screen display, video monitor, television-like device, and/or a television. The display 2020 may be digital and/or analog. In embodiments, the display 2020 may be a holographic display. Also, the display 2020 may be a transparent surface that may receive a visual projection. Such projections may convey various forms of information, images, and/or objects. For example, such projections may be a visual overlay for a mobile augmented reality (MAR) application. Under the control of one or more software applications 2016, the platform 2002 may display user interface 2022 on the display 2020.

In embodiments, content services device(s) 2030 may be hosted by any national, international and/or independent service and thus accessible to the platform 2002 via the Internet, for example. The content services device(s) 2030 may be coupled to the platform 2002 and/or to the display 2020. The platform 2002 and/or content services device(s) 2030 may be coupled to a network 2060 to communicate (e.g., send and/or receive) media information to and from network 2060. The content delivery device(s) 2040 also may be coupled to the platform 2002 and/or to the display 2020.

In embodiments, the content services device(s) 2030 may comprise a cable television box, personal computer, network, telephone, Internet enabled devices or appliance capable of delivering digital information and/or content, and any other similar device capable of unidirectionally or bidirectionally communicating content between content providers and platform 2002 and/display 2020, via network 2060 or directly. It will be appreciated that the content may be communicated unidirectionally and/or bidirectionally to and from any one of the components in system 2000 and a content provider via network 2060. Examples of content may include any media information including, for example, video, music, medical and gaming information, and so forth.

The content services device(s) 2030 receives content such as cable television programming including media information, digital information, and/or other content. Examples of content providers may include any cable or satellite television or radio or Internet content providers. The provided examples are not meant to limit embodiments.

In embodiments, the platform 2002 may receive control signals from a navigation controller 2050 having one or more navigation features. The navigation features of the controller 2050 may be used to interact with the user interface 2022, for example. In embodiments, the navigation controller 2050 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of the controller 2050 may be echoed on a display (e.g., display 2020) by movements of a pointer, cursor, focus ring, or other visual indicators displayed on the display. For example, under the control of software applications 2016, the navigation features located on the navigation controller 2050 may be mapped to virtual navigation features displayed on the user interface 2022, for example. In embodiments, the controller 2050 may not be a separate component but integrated into the platform 2002 and/or the display 2020. Embodiments, however, are not limited to the elements or in the context shown or described herein.

In embodiments, drivers (not shown) may comprise technology to enable users to instantly turn on and off the platform 2002 like a television with the touch of a button after initial boot-up, when enabled, for example. Program logic may allow the platform 2002 to stream content to media adaptors or other content services device(s) 2030 or content delivery device(s) 2040 when the platform is turned “off.” In addition, chipset 2005 may comprise hardware and/or software support for (5.1) surround sound audio and/or high definition (7.1) surround sound audio, for example. Drivers may include a graphics driver for integrated graphics platforms. In embodiments, the graphics driver may comprise a peripheral component interconnect (PCI) Express graphics card.

In various embodiments, any one or more of the components shown in the system 2000 may be integrated. For example, the platform 2002 and the content services device(s) 2030 may be integrated, or the platform 2002 and the content delivery device(s) 2040 may be integrated, or the platform 2002, the content services device(s) 2030, and the content delivery device(s) 2040 may be integrated, for example. In various embodiments, the platform 2002 and the display 2020 may be an integrated unit. The display 2020 and content service device(s) 2030 may be integrated, or the display 2020 and the content delivery device(s) 2040 may be integrated, for example. These examples are not meant to limit the embodiments.

In various embodiments, system 2000 may be implemented as a wireless system, a wired system, or a combination of both. When implemented as a wireless system, system 2000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 2000 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

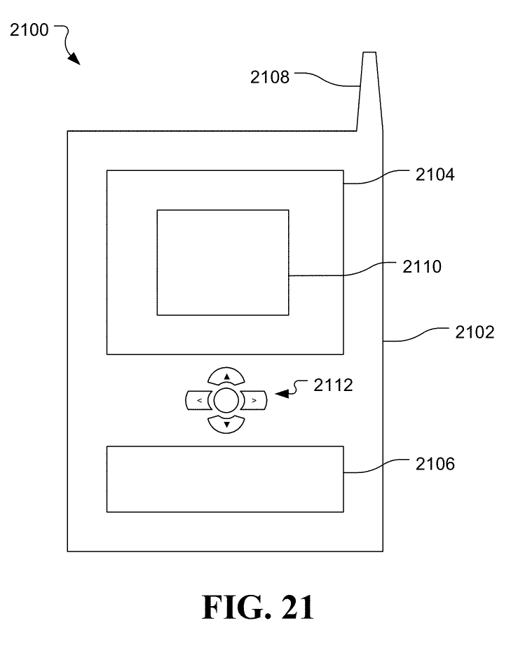

The platform 2002 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 21.

As described above, the system 2000 may be embodied in varying physical styles or form factors. FIG. 21 illustrates embodiments of a small form factor device 2100 in which the system 2000 may be embodied. In embodiments, for example, the device 2100 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 21, the device 2100 may comprise a housing 2102, a display 2104, an input/output (I/O) device 2106, and an antenna 2108. The device 2100 also may comprise navigation features 2112. The display 2104 may comprise any suitable display unit for displaying information appropriate for a mobile computing device. The I/O device 2106 may comprise any suitable I/O device for entering information into a mobile computing device. Examples for the I/O device 2106 may include an alphanumeric keyboard, a numeric keypad, a touch pad, input keys, buttons, switches, rocker switches, microphones, speakers, voice recognition device and software, and so forth. Information also may be entered into the device 2100 by way of microphone. Such information may be digitized by a voice recognition device. The embodiments are not limited in this context.

### Additional Notes and Examples

Example 1 may include a system to perform efficient video coding, including: a partition and mode simplification analyzer, the partition and mode simplification analyzer including a substrate and logic coupled to the substrate, where the logic is to: determine a plurality of spatial features and temporal features for a current largest coding unit of a current frame of the video sequence; determine a limited number of partition maps and a limited number of mode subsets for the current largest coding unit of the current frame based at least in part on the spatial features and temporal features; and perform rate distortion optimization operations during coding of the video sequence, where the rate distortion optimization operations have a limited complexity based at least in part on the limited number of partition maps and the limited number of mode subsets.

Example 2 may include the system of Example 1, where the limited number of partition maps are selected to be two partition maps and the limited number of mode subsets are selected to be two modes per partition.

Example 3 may include the system of Example 1, where the limited number of partition maps include a primary partitioning map and an optional alternate partitioning map; and where both the primary partitioning map and the alternate partitioning map are generated by recursive cascading of split decisions with logical control.

Example 4 may include the system of Example 1, where the limited number of partition maps are generated based at least in part on the limited number of mode subsets.

Example 5 may include the system of Example 1, where the spatial features include one or more of spatial-detail metrics and relationships, where the spatial feature values are based on the following spatial-detail metrics and relationships: a spatial complexity per-pixel detail metric (SCpp) based at least in part on spatial gradient of a square root of average row difference square and average column difference squares over a given block of pixels, and a spatial complexity variation metric (SCvar) based at least in part on a difference between a minimum and a maximum spatial complexity per-pixel in a quad split.

Example 5 may include the system of Example 5, where the temporal features include one or more of temporal-variation metrics and relationships, where the temporal features are based on the following temporal-variation metrics and relationships: a motion vector differentials metric (mvd), a temporal complexity per-pixel metric (SADpp) based at least in part on a motion compensated sum of absolute difference per-pixel, a temporal complexity variation metric (SADvar) based at least in part on a ratio between a minimum and a maximum sum of absolute difference-per-pixel in a quad split, and a temporal complexity reduction metric (SADred) based at least in part on a ratio between the split and non-split sum of absolute difference-per-pixel in a quad split.

Example 7 may include the system of Example 6, where the determination of the limited number of mode subsets is based at least in part on one or more of the following intelligent encoding functions (IEF): a force intra mode function, a try intra mode function, and a disable skip mode function; where the force intra mode function is based at least in part on a threshold determination associated with the spatial complexity per-pixel detail metric (SCpp), the temporal complexity per-pixel metric (SADpp), and the motion vector differentials metric (mvd); where the try intra mode function is based at least in part on a threshold determination associated with the spatial complexity per-pixel detail metric (SCpp), the temporal complexity per-pixel metric (SADpp), and the motion vector differentials metric (mvd); and where the disable skip mode function is based at least in part on a threshold determination associated with the temporal complexity per-pixel metric (SADpp), and motion vector differentials metric (mvd).

Example 8 may include the system of Example 6, where the determination of the limited number of partition maps is based at least in part on one or more of the following intelligent encoding functions (IEF): a not split partition map-type function and a force split partition map-type function; where the not split partition map-type function is based at least in part on a threshold determination associated with the spatial complexity per-pixel detail metric (SCpp), the temporal complexity per-pixel metric (SADpp), the temporal complexity variation metric (SADvar), the temporal complexity reduction metric (SADred); and where the force split partition map-type function is based at least in part on a threshold determination associated with the spatial complexity per-pixel detail metric (SCpp), the temporal complexity per-pixel metric (SADpp), the temporal complexity variation metric (SADvar), and the temporal complexity reduction metric (SADred).

Example 9 may include the system of Example 1, where the determination of the limited number of mode subsets is based at least in part on one or more of the following intelligent encoding functions (IEF): a force intra mode function, a try intra mode function, and a disable skip mode function; where the determination of the limited number of partition maps is based at least in part on one or more of the following intelligent encoding functions (IEF): a not split partition map-type function and a force split partition map-type function; where the force intra mode function, the try intra mode function, the disable skip mode function, the not split partition map-type function, the force split partition map-type function are based at least in part on generated parameter values; where the generated parameter values depend at least in part on one or more of the following: a coding unit size, a frame level, and a representative quantizer;

where the frame level indicates one or more of the following: a P-frame, a GBP-frame, a level one B-frame, a level two B-frame, a level three B-frame; where the representative quantizer includes a true quantization parameter that has been adjusted in value based at least in part on a frame type of the current coding unit of the current frame; and where the coding unit size-type parameter value indicates one or more of the following: a sixty-four by sixty-four size coding unit, a thirty-two by thirty-two size coding unit, a sixteen by sixteen size coding unit, and an eight by eight size coding unit.

Example 10 may include the system of Example 1, further including: an offline trainer to: input a pre-determined collection of training videos; encode the training videos with an ideal reference encoder to determine ideal mode and partitioning decisions based at least in part on one or more of the following: a plurality of fixed quantizers, a plurality of fixed data-rates, and a plurality of group of pictures structures; calculate spatial metrics and temporal metrics that form the corresponding spatial features and temporal features, based at least in part on the training videos; and determine weights, exponents, and thresholds for intelligent encoding functions (IEF) such that prediction of an ideal mode and partitioning decisions using the obtained spatial metrics and temporal metrics by calculating the intelligent encoding functions (IEF) is maximized.

Example 11 may include at least one computer readable storage medium including a set of instructions, which when executed by a computing system, cause the computing system to: determine a plurality of spatial features and temporal features for a current largest coding unit of a current frame of the video sequence; determine a limited number of partition maps and a limited number of mode subsets for the current largest coding unit of the current frame based at least in part on the spatial features and temporal features; and perform rate distortion optimization operations during coding of the video sequence, where the rate distortion optimization operations have a limited complexity based at least in part on the limited number of partition maps and the limited number of mode subsets.

Example 12 may include the at least one computer readable storage medium of Example 11, where the limited number of partition maps are selected to be two partition maps and the limited number of mode subsets are selected to be two modes per partition.

Example 13 may include the at least one computer readable storage medium of Example 11, where the limited number of partition maps include a primary partitioning map and an optional alternate partitioning map; and

where both the primary partitioning map and the alternate partitioning map are generated by recursive cascading of split decisions with logical control.

Example 14 may include the at least one computer readable storage medium of Example 11, where the limited number of partition maps are generated based at least in part on the limited number of mode subsets.

Example 15 may include a method to perform efficient video coding, including: determining a plurality of spatial features and temporal features for a current largest coding unit of a current frame of the video sequence; determining a limited number of partition maps and a limited number of mode subsets for the current largest coding unit of the current frame based at least in part on the spatial features and temporal features; and performing rate distortion optimization operations during coding of the video sequence, where the rate distortion optimization operations have a limited complexity based at least in part on the limited number of partition maps and the limited number of mode subsets.

Example 16 may include the method of Example 15, where the limited number of partition maps are selected to be two partition maps and the limited number of mode subsets are selected to be two modes per partition.

Example 17 may include the method of Example 15, where the limited number of partition maps include a primary partitioning map and an optional alternate partitioning map; and where both the primary partitioning map and the alternate partitioning map are generated by recursive cascading of split decisions with logical control.

Example 18 may include the method of Example 15, where the limited number of partition maps are generated based at least in part on the limited number of mode subsets.

Example 19 may include an apparatus for coding of a video sequence, including:

a partition and mode simplification analyzer, the partition and mode simplification analyzer including: a content analyzer and features generator to determine a plurality of spatial features and temporal features for a current largest coding unit of a current frame of the video sequence; a partitions and mode subset generator to determine a limited number of partition maps and a limited number of mode subsets for the current largest coding unit of the current frame based at least in part on the spatial features and temporal features; and a coder controller of a video coder communicatively coupled to the partition and mode simplification analyzer, the coder controller to perform rate distortion optimization operations during coding of the video sequence, where the rate distortion optimization operations have a limited complexity based at least in part on the limited number of partition maps and the limited number of mode subsets.

Example 20 may include the apparatus of Example 19, where the limited number of partition maps are selected to be two partition maps and the limited number of mode subsets are selected to be two modes per partition.

Example 21 may include the apparatus of Example 19, where the limited number of partition maps include a primary partitioning map and an optional alternate partitioning map; and where both the primary partitioning map and the alternate partitioning map are generated by recursive cascading of split decisions with logical control.

Example 22 may include the apparatus of Example 19, where the partitions and mode subsets generator generates the limited number of partition maps based at least in part on the limited number of mode subsets.

Example 23 may include an apparatus, including means for performing a method as described in any preceding Example.

Example 24 may include machine-readable storage including machine-readable instructions which, when executed, implement a method or realize an apparatus as described in any preceding Example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments of this have been described in connection with particular examples thereof, the true scope of the embodiments should not be so limited since other modifications will become apparent to the skilled practitioner upon a study of the drawings, specification, and following claims.

We claim:

1. A system to perform efficient video coding, comprising:
a partition and mode simplification analyzer, the partition and mode simplification analyzer including a substrate and logic coupled to the substrate, wherein the logic is to:
determine a plurality of spatial features and temporal features for a current largest coding unit of a current frame of the video sequence;
determine a limited number of partition maps and a limited number of mode subsets for the current largest coding unit of the current frame based at least in part on the spatial features and temporal features; and
perform rate distortion optimization operations during coding of the video sequence, wherein the rate distortion optimization operations have a limited complexity based at least in part on the limited number of partition maps and the limited number of mode subsets.

2. The system of claim 1, wherein the limited number of partition maps are selected to be two partition maps and the limited number of mode subsets are selected to be two modes per partition.

3. The system of claim 1, wherein the limited number of partition maps include a primary partitioning map and an optional alternate partitioning map; and
wherein both the primary partitioning map and the alternate partitioning map are generated by recursive cascading of split decisions with logical control.

4. The system of claim 1, wherein the limited number of partition maps are generated based at least in part on the limited number of mode subsets.

5. The system of claim 1, wherein the spatial features include one or more of spatial-detail metrics and relationships, wherein the spatial feature values are based on the following spatial-detail metrics and relationships: a spatial complexity per-pixel detail metric based at least in part on spatial gradient of a square root of average row difference square and average column difference squares over a given block of pixels, and a spatial complexity variation metric based at least in part on a difference between a minimum and a maximum spatial complexity per-pixel in a quad split.

6. The system of claim 5, wherein the temporal features include one or more of temporal-variation metrics and relationships, wherein the temporal features are based on the following temporal-variation metrics and relationships: a motion vector differentials metric, a temporal complexity per-pixel metric based at least in part on a motion compensated sum of absolute difference per-pixel, a temporal complexity variation metric based at least in part on a ratio between a minimum and a maximum sum of absolute difference-per-pixel in a quad split, and a temporal complexity reduction metric based at least in part on a ratio between the split and non-split sum of absolute difference-per-pixel in a quad split.

7. The system of claim 6, wherein the determination of the limited number of mode subsets is based at least in part on one or more of the following intelligent encoding functions: a force intra mode function, a try intra mode function, and a disable skip mode function;
wherein the force intra mode function is based at least in part on a threshold determination associated with the spatial complexity per-pixel detail metric, the temporal complexity per-pixel metric, and the motion vector differentials metric;
wherein the try intra mode function is based at least in part on a threshold determination associated with the spatial complexity per-pixel detail metric, the temporal complexity per-pixel metric, and the motion vector differentials metric; and
wherein the disable skip mode function is based at least in part on a threshold determination associated with the temporal complexity per-pixel metric, and motion vector differentials metric.

8. The system of claim 6, wherein the determination of the limited number of partition maps is based at least in part on one or more of the following intelligent encoding functions: a not split partition map-type function and a force split partition map-type function;
wherein the not split partition map-type function is based at least in part on a threshold determination associated with the spatial complexity per-pixel detail metric, the temporal complexity per-pixel metric, the temporal complexity variation metric (SADvar), the temporal complexity reduction metric; and
wherein the force split partition map-type function is based at least in part on a threshold determination associated with the spatial complexity per-pixel detail metric (SCpp), the temporal complexity per-pixel metric, the temporal complexity variation metric, and the temporal complexity reduction metric.

9. The system of claim 1,
wherein the determination of the limited number of mode subsets is based at least in part on one or more of the following intelligent encoding functions: a force intra mode function, a try intra mode function, and a disable skip mode function;
wherein the determination of the limited number of partition maps is based at least in part on one or more of the following intelligent encoding functions: a not split partition map-type function and a force split partition map-type function;
wherein the force intra mode function, the try intra mode function, the disable skip mode function, the not split partition map-type function, the force split partition map-type function are based at least in part on generated parameter values;
wherein the generated parameter values depend at least in part on one or more of the following: a coding unit size, a frame level, and a representative quantizer;
wherein the frame level indicates one or more of the following: a P-frame, a GBP-frame, a level one B-frame, a level two B-frame, a level three B-frame;
wherein the representative quantizer includes a true quantization parameter that has been adjusted in value based at least in part on a frame type of the current coding unit of the current frame; and
wherein the coding unit size-type parameter value indicates one or more of the following: a sixty-four by sixty-four size coding unit, a thirty-two by thirty-two size coding unit, a sixteen by sixteen size coding unit, and an eight by eight size coding unit.

10. The system of claim 1, further comprising:
an offline trainer to:
input a pre-determined collection of training videos;
encode the training videos with an ideal reference encoder to determine ideal mode and partitioning decisions based at least in part on one or more of the following: a plurality of fixed quantizers, a plurality of fixed data-rates, and a plurality of group of pictures structures;
calculate spatial metrics and temporal metrics that form the corresponding spatial features and temporal features, based at least in part on the training videos; and
determine weights, exponents, and thresholds for intelligent encoding functions (IEF) such that prediction of an ideal mode and partitioning decisions using the obtained spatial metrics and temporal metrics by calculating the intelligent encoding functions (IEF) is maximized.

11. At least one computer readable storage medium comprising a set of instructions, which when executed by a computing system, cause the computing system to:
determine a plurality of spatial features and temporal features for a current largest coding unit of a current frame of the video sequence;
determine a limited number of partition maps and a limited number of mode subsets for the current largest coding unit of the current frame based at least in part on the spatial features and temporal features; and
perform rate distortion optimization operations during coding of the video sequence, wherein the rate distortion optimization operations have a limited complexity based at least in part on the limited number of partition maps and the limited number of mode subsets.

12. The at least one computer readable storage medium of claim 11, wherein the limited number of partition maps are selected to be two partition maps and the limited number of mode subsets are selected to be two modes per partition.

13. The at least one computer readable storage medium of claim 11, wherein the limited number of partition maps include a primary partitioning map and an optional alternate partitioning map; and
wherein both the primary partitioning map and the alternate partitioning map are generated by recursive cascading of split decisions with logical control.

14. The at least one computer readable storage medium of claim 11, wherein the limited number of partition maps are generated based at least in part on the limited number of mode subsets.

15. A method to perform efficient video coding, comprising:
determining a plurality of spatial features and temporal features for a current largest coding unit of a current frame of the video sequence;
determining a limited number of partition maps and a limited number of mode subsets for the current largest coding unit of the current frame based at least in part on the spatial features and temporal features; and
performing rate distortion optimization operations during coding of the video sequence, wherein the rate distortion optimization operations have a limited complexity based at least in part on the limited number of partition maps and the limited number of mode subsets.

16. The method of claim 15, wherein the limited number of partition maps are selected to be two partition maps and the limited number of mode subsets are selected to be two modes per partition.

17. The method of claim 15, wherein the limited number of partition maps include a primary partitioning map and an optional alternate partitioning map; and
wherein both the primary partitioning map and the alternate partitioning map are generated by recursive cascading of split decisions with logical control.

18. The method of claim 15, wherein the limited number of partition maps are generated based at least in part on the limited number of mode subsets.

19. An apparatus for coding of a video sequence, comprising:
a partition and mode simplification analyzer, the partition and mode simplification analyzer comprising:
a content analyzer and features generator to determine a plurality of spatial features and temporal features for a current largest coding unit of a current frame of the video sequence;
a partitions and mode subset generator to determine a limited number of partition maps and a limited number of mode subsets for the current largest coding unit of the current frame based at least in part on the spatial features and temporal features; and
a coder controller of a video coder communicatively coupled to the partition and mode simplification analyzer, the coder controller to perform rate distortion optimization operations during coding of the video sequence, wherein the rate distortion optimization operations have a limited complexity based at least in part on the limited number of partition maps and the limited number of mode subsets.

20. The apparatus of claim 19, wherein the limited number of partition maps are selected to be two partition maps and the limited number of mode subsets are selected to be two modes per partition.

21. The apparatus of claim 19, wherein the limited number of partition maps include a primary partitioning map and an optional alternate partitioning map; and
wherein both the primary partitioning map and the alternate partitioning map are generated by recursive cascading of split decisions with logical control.

22. The apparatus of claim 19, wherein the partitions and mode subsets generator generates the limited number of partition maps based at least in part on the limited number of mode subsets.
